(19) United States
(12) Patent Application Publication
(10) Pub. No.: US 2019/0223144 A1
(43) Pub. Date: Jul. 18, 2019

(54) SYSTEMS, DEVICES, AND METHODS FOR DETERMINING A LOCATION OF A COMPUTING DEVICE VIA A CURRENT STATE OF THE COMPUTING DEVICE AND SIGNALS RECEIVED BY AND/OR FROM OTHER COMPUTING DEVICES

(71) Applicant: Tink Labs Limited, Hong Kong (CN)

(72) Inventors: Philip Yuen, Hong Kong (CN); Chung Yin Terence Kwok, Hong Kong (CN); Chin Man Leon Chung, Hong Kong (CN); Chak Man Lam, Hong Kong (CN); Cham Him Mak, Hong Kong (CN)

(21) Appl. No.: 16/327,277

(22) PCT Filed: May 17, 2017
(86) PCT No.: PCT/CN2017/084779

§ 371 Date: Feb. 21, 2019

(51) Int. Cl. H04W 64/00; H04W 52/02; H04W 72/04

(52) U.S. Cl. CPC H04W 64/006; H04W 72/048; H04W 52/0251

(57) ABSTRACT

Embodiments relate to location determination of computing devices. An example system includes a processor configurable to identify, from a first device, a second device transmitting wireless signals to the first device. The processor is configurable to determine, from the first device, a signal level of the wireless signals received by the first device from the second device. The processor is configurable to identify, from the first device, a third device transmitting wireless signals to the second device. The processor is configurable to determine, from the first device, a signal level of the wireless signals received by the second device from the third device. The processor is configurable to derive a location status of the first device based on the identification of the second and third devices and the signal levels of the wireless signals received by the first and second devices from the second and third devices, respectively.

### TECHNICAL FIELD

The present disclosure relates generally to location determination of computing devices, and more specifically, the present disclosure relates generally to systems, devices, and methods for determining a location of computing devices via a current state of the computing devices.

### BACKGROUND

Computing devices come in various shapes, sizes, configurations, and capabilities. In respect to mobile computing devices, mobile computing devices will typically include wireless communication capabilities so as to enable users to, among other things, access the Internet to search for information, interact with others via electronic mail (email) messages and/or social media networks, and conduct online shopping and other forms of e-commerce.

Mobile computing devices are typically capable of performing wireless communications in one or more of a plurality of ways. For example, mobile computing devices may be capable of wireless communications through 3G networks, 4G networks, 4G LTE networks, or the like, such as via a subscriber identity module (or “SIM card”), or the like. Mobile computing devices may also be capable of performing wireless communications via wireless local area networks (or “WLAN”), such as Wi-Fi networks and Li-Fi networks, and/or via other forms of short range wireless signals when the mobile computing device is within range of (i.e., capable of receiving) such wireless signals. Today, a significant portion of the mobile computing devices available on the market are configurable to communicate through some, most, or all of these and other forms of wireless communications.

### BRIEF SUMMARY

The popularity and widespread use of mobile computing devices today stem largely from the convenience and portability of such devices, enabling users to perform wireless communications, access information, and perform e-commerce at virtually any time and location. Situations may arise, however, when there is a need to determine a location or location status (herein also referred to as “location determination”) of one or more mobile computing devices.

Recent developments in mobile computing technology have enabled location determination via the use of global positioning system (GPS) technology (e.g., via a GPS receiver) built into a computing device. While GPS technology continues to improve in terms of accuracy, processing speed, and coverage, it is recognized in the present disclosure that GPS technology in certain situations, including those described in the present disclosure, are unable to satisfactorily determine a location and/or location status of a computing device. Accordingly, it is recognized in the present disclosure that there is a need for alternative, additional, and/or improved approaches to determining a location and/or location status of computing devices.

Present example embodiments relate generally to and/or comprise systems, subsystems, processors, devices, logic, and methods for addressing conventional problems, including those described above and in the present disclosure, and more specifically, example embodiments relate to systems, subsystems, processors, devices, logic, and methods of determining a location or location status of one or more computing devices.

In an exemplary embodiment, a system for determining a location of a computing device is described. The system may comprise a processor. The processor may be configurable to communicate, via a communication channel, with a first computing device. The processor may be further configurable to determine, from the first computing device via the communication channel, a current state of the first computing device. The current state of the first computing device may be a charging state or a non-charging state. The charging state may be a state in which an energy source of the first computing device is connected to and/or being charged by an external energy source. The non-charging state may be a state in which the energy source of the first computing device is not connected to and/or not being charged by the external energy source. The processor may be further configurable to identify, from the first computing device via the communication channel, a second computing device, the second computing device being a computing device transmitting wireless signals directly to the first computing device. The processor may be further configurable to determine, from the first computing device via the communication channel, a current state of the second computing device. The current state of the second computing device may be a charging state or a non-charging state. The charging state may be a state in which an energy source of the second computing device is connected to and/or being charged by an external energy source. The non-charging state may be a state in which the energy source of the second computing device is not connected to and/or not being charged by the external energy source. The processor may be further configurable to determine, from the first computing device via the communication channel, a signal level of the wireless signals received by the first computing device from the second computing device. The processor may be further configurable to identify, from the first computing device via the communication channel, a third computing device, the third computing device being a computing device transmitting wireless signals directly to the second computing device. The processor may be further configurable to determine, from the first computing device via the communication channel, a current state of the third computing device. The current state of the third computing device may be a charging state or a non-charging state. The charging state may be a state in which an energy source of the third computing device is connected to and/or being charged by an external energy source. The non-charging state may be a state in which the energy source of the third computing device is not connected to and/or not being charged by the external energy source. The processor may be further configurable to determine, from the first computing device via the communication channel, a signal level of the wireless signals received by the second computing device from the third computing device. The processor may be further configurable to derive a location status of the first computing device based on at least the identification of the second and third computing devices, the current state of the first computing device, the current state of the second computing device, the current state of the third computing device, and the signal levels of the wireless signals received by the first and second computing devices from the second and third computing devices, respectively.

In another exemplary embodiment, a method for determining a location of a computing device is described. The method includes establishing a communication channel between a processor and a first computing device. The method may further include determining, by the processor via the communication channel, a current state of the first computing device. The current state of the first computing device may be a charging state or a non-charging state. The charging state may be a state in which an energy source of the first computing device is connected to and/or being charged by an external energy source. The non-charging state may be a state in which the energy source of the first computing device is not connected to and/or not being charged by the external energy source. The method may further include identifying, by the processor via the communication channel, a second computing device, the second computing device being a computing device transmitting wireless signals directly to the first computing device. The method may further include determining, by the processor via the communication channel, a current state of the second computing device. The current state of the second computing device may be a charging state or a non-charging state. The charging state may be a state in which an energy source of the second computing device is connected to and/or being charged by an external energy source. The non-charging state may be a state in which the energy source of the second computing device is not connected to and/or not being charged by the external energy source. The method may further include determining, by the processor via the communication channel, a signal level of the wireless signals received by the first computing device from the second computing device. The method may further include identifying, by the processor via the communication channel, a third computing device, the third computing device being a computing device transmitting wireless signals directly to the second computing device. The method may further include determining, by the processor via the communication channel, a current state of the third computing device. The current state of the third computing device may be a charging state or a non-charging state. The charging state may be a state in which an energy source of the third computing device is connected to and/or being charged by an external energy source. The non-charging state may be a state in which the energy source of the third computing device is not connected to and/or not being charged by the external energy source. The method may further include determining, by the processor via the communication channel, a signal level of the wireless signals received by the second computing device from the third computing device. The method may further include deriving a location status of the first computing device based on at least the identification of the second and third computing devices, the current state of the first computing device, the current state of the second computing device, the current state of the third computing device, and the signal levels of the wireless signals received by the first and second computing devices from the second and third computing devices, respectively.

In another exemplary embodiment, a system for determining a location of a computing device is described. The system may include a processor. The processor may be configurable to communicate, via a communication channel, with a first computing device. The processor may be further configurable to identify, from the first computing device via the communication channel, a second computing device, the second computing device being a computing device transmitting wireless signals directly to the first computing device. The processor may be further configurable to determine, from the first computing device via the communication channel, a signal level of the wireless signals received by the first computing device from the second computing device. The processor may be further configurable to identify, from the first computing device via the communication channel, a third computing device, the third computing device being a computing device transmitting wireless signals directly to the second computing device. The processor may be further configurable to determine, from the first computing device via the communication channel, a signal level of the wireless signals received by the second computing device from the third computing device. The processor may be further configurable to derive a location status of the first computing device based on at least the identification of the second and third computing devices and the signal levels of the wireless signals received by the first and second computing devices from the second and third computing devices, respectively.

In another exemplary embodiment, a method for determining a location of a computing device is described. The method may include establishing a communication channel between a processor and a first computing device. The method may further include identifying, by the processor via the communication channel, a second computing device, the second computing device being a computing device transmitting wireless signals directly to the first computing device. The method may further include determining, by the processor via the communication channel, a signal level of the wireless signals received by the first computing device from the second computing device. The method may further include identifying, by the processor via the communication channel, a third computing device, the third computing device being a computing device transmitting wireless signals directly to the second computing device. The method may further include determining, by the processor via the communication channel, a signal level of the wireless signals received by the second computing device from the third computing device. The method may further include deriving, by the processor, a location status of the first computing device based on at least the identification of the second and third computing devices and the signal levels of the wireless signals received by the first and second computing devices from the second and third computing devices, respectively.

In another exemplary embodiment, a method for determining a location of a computing device is described. The method may include establishing a communication channel between a processor and a first computing device. The method may further include determining, by the first computing device, an identification of a second computing device, the second computing device being a computing device transmitting wireless signals directly to the first computing device. The method may further include determining, by the first computing device, a signal level of the wireless signals received by the first computing device from the second computing device. The method may further include determining, by the first computing device, an identification of a third computing device, the third computing device being a computing device transmitting wireless signals directly to the second computing device. The method may further include determining, by the first computing device, a signal level of the wireless signals received by the second computing device from the third computing device. The method may further include deriving, by the first computing device, a location status of the first computing device based on at least the identification of the second and third computing devices and the signal levels of the wireless signals received by the first and second computing devices from the second and third computing devices, respectively. The method may further include receiving, by the processor via the communication channel, the location status of the first computing device.

### BRIEF DESCRIPTION OF THE DRAWINGS

For a more complete understanding of the present disclosure, example embodiments, and their advantages, reference is now made to the following description taken in conjunction with the accompanying drawings, in which like reference numbers indicate like features, and:

FIG. 1 is an illustration of an example embodiment of a system for determining a location of a computing device;

FIG. 2A is an illustration of another example embodiment of a system for determining a location of a computing device;

FIG. 2B is an illustration of another example embodiment of a system for determining a location of a computing device;

FIG. 2C is an illustration of another example embodiment of a system for determining a location of a computing device;

FIG. 3 is an illustration of another example embodiment of a system for determining a location of a computing device;

FIG. 4 is an illustration of an example embodiment of a charge state of a computing device;

FIG. 5 is an illustration of an example embodiment of a communication state of a computing device;

FIG. 6 is an illustration of an example embodiment of a method for determining a location of a computing device; and

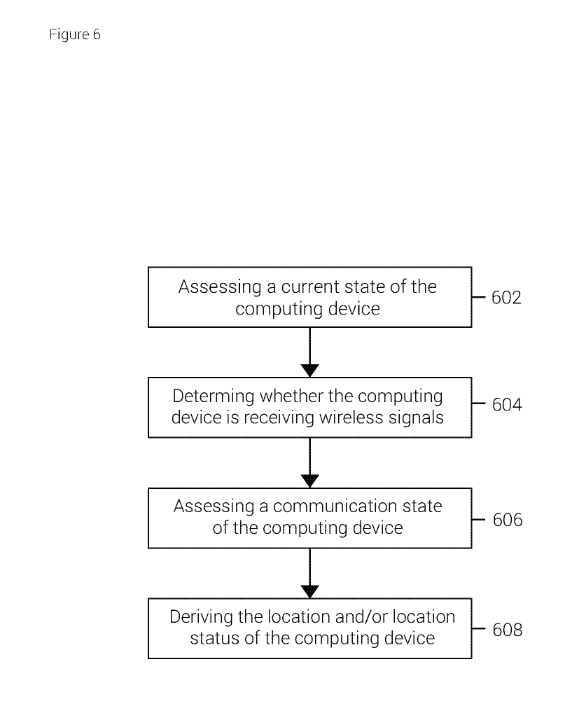

FIG. 7 is an illustration of another example embodiment of a method for determining a location of a computing device.

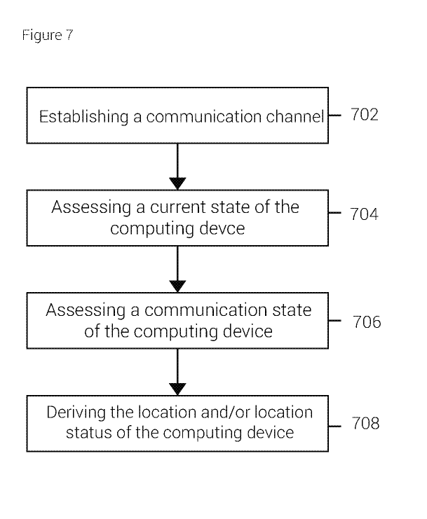

Although similar reference numbers may be used to refer to similar elements in the figures for convenience, it can be appreciated that each of the various example embodiments may be considered to be distinct variations.

Example embodiments will now be described with reference to the accompanying drawings, which form a part of the present disclosure and which illustrate example embodiments which may be practiced. As used in the present disclosure and the appended claims, the terms “embodiment,” “example embodiment,” “exemplary embodiment,” and “present embodiment” do not necessarily refer to a single embodiment, although they may, and various example embodiments may be readily combined and/or interchanged without departing from the scope or spirit of example embodiments. Furthermore, the terminology as used in the present disclosure and the appended claims is for the purpose of describing example embodiments only and is not intended to be limitations. In this respect, as used in the present disclosure and the appended claims, the term “in” may include “in” and “on,” and the terms “a,” “an,” and “the” may include singular and plural references. Furthermore, as used in the present disclosure and the appended claims, the term “by” may also mean “from,” depending on the context. Furthermore, as used in the present disclosure and the appended claims, the term “if” may also mean “when” or “upon,” depending on the context. Furthermore, as used in the present disclosure and the appended claims, the words “and/or” may refer to and encompass any and all possible combinations of one or more of the associated listed items.

### DETAILED DESCRIPTION

Mobile computing devices are typically capable of performing wireless communications in one or more of a plurality of ways. For example, mobile computing devices, such as many of the smart phones, phablets, and tablets running the Android or iOS operating systems available today, may be capable of wireless communications through 3G networks, 4G networks, 4G LTE networks, or the like, such as via a subscriber identity module (or “SIM card”), or the like. Mobile computing devices may also be capable of performing wireless communications via wireless local area networks (or “WLANs”), such as Wi-Fi networks and Li-Fi networks, and/or via other forms, such as Bluetooth, NFC, and other forms of short range wireless signals, when the mobile computing device is within range of (i.e., capable of receiving) such wireless signals. Today, a significant portion of the mobile computing devices available on the market are configurable to communicate through some, most, or all of these and other forms of wireless communications.

In view of the popularity and widespread use of mobile computing devices today, it is recognized that situations may arise when there is a need or want to determine and/or monitor, either on demand, periodically, continuously, and/or based on an event occurring, a location or location status (herein also referred to as “location determination”) of one or more mobile computing devices, such as in situations where one or more of the mobile computing devices are provided by a person, organization, or the like, to one or more users for use on a temporary, permanent, non-fixed term, fixed term, exclusive, and/or non-exclusive basis (each as applicable).

As a non-limiting example, in situations where mobile computing devices are issued by an employer to its employees, the employer may have an interest, want, and/or need to be able to determine and/or monitor a location or location status of such mobile computing devices issued to its employees. As another example, in situations where mobile computing devices are issued by an educational institution to its students, teachers, and/or other employees, the educational institution may have an interest, want, and/or need to be able to determine and/or monitor a location or location status of such mobile computing devices issued to its students, teachers, and/or other employees. In yet another example, in situations where mobile computing devices are issued by a hotel to its hotel guests and/or employees, the hotel may have an interest, want, and/or need to be able to determine and/or monitor a location or location status of such mobile computing devices issued to its hotel guests and/or employees.

Recent developments in mobile computing technology have enabled location determination via the use of global positioning system (GPS) technology (e.g., a GPS receiver) built into the computing device. While GPS technology continues to improve in terms of accuracy, processing speed, and coverage, it is recognized in the present disclosure that GPS technology alone in certain situations, including those described above and in the present disclosure, may be unable to satisfactorily determine a location and/or location status of the computing device.

As a non-limiting example, there may be certain areas in certain geographical locations, buildings, homes, and the like, that receive weak, intermittent, disrupted, and/or no GPS signals, in which case location determination using GPS technology becomes difficult, inaccurate, or not possible. Oftentimes, the collective physical aspects of such geographical locations, buildings, homes, and the like (e.g., several thick walls, floors, and/or other structure nearby and/or surrounding the computing device; multiple floors above and/or multiple walls and/or other structures nearby and/or surrounding the computing device; use of the computing device in underground areas; etc.), certain weather conditions, and/or certain terrestrial and/or non-terrestrial factors or events may be contributing factors for such difficulty or inability to use GPS technology for location determination.

As another non-limiting example, for buildings with multiple floors, such as office buildings, educational institutions, and hotels, it is oftentimes difficult or not possible to satisfactorily determine a location or location status (e.g., a specific or approximate location on a specific floor of the building) of a computing device via GPS technology due to the inherent nature of GPS signals requiring a relatively unobstructed path or “line of sight” between the computing device and GPS satellites.

In view of the non-limiting example situations described above and in the present disclosure, as well as other situations contemplated in the present disclosure, such as situations where a computing device is not equipped with GPS technology or the GPS feature is turned off or not working, it is recognized in the present disclosure that a need exists for an alternative, additional, and/or improved approach to determining a location and/or location status of one or more computing devices.

Present example embodiments relate generally to and/or comprise systems, subsystems, processors, devices, logic, and methods for addressing conventional problems, including those described above and in the present disclosure, and more specifically, example embodiments relate to systems, subsystems, processors, devices, logic, and methods of determining a location or location status of one or more computing devices. Although example embodiments may be described in the present disclosure as pertaining to and/or for use with multi-floor and/or multi-room settings, such as office buildings, hotels, convention centers, and tourist destinations, it is to be understood that example embodiments may also be applicable to and/or for use in other environments, surroundings, situations, circumstances, and/or applications, including outdoor environments and locations, single floor setting, etc., without departing from the teachings of the present disclosure. It is also to be understood in the present disclosure that the terms “device,” “computing device,” “communication device,” “transmitting device,” “system,” and/or the like, may be interchangeably used to refer to one or more example embodiments of a system, computing device, communication device, and/or transmitting device (as applicable) based on the functionality or use of such devices in the determination of a location or location status of a computing device. These example embodiments will now be described below with reference to the accompanying figures, which form a part of the present disclosure.

Example Embodiments of a System for Determining a Location of a Computing Device (e.g., System 100).

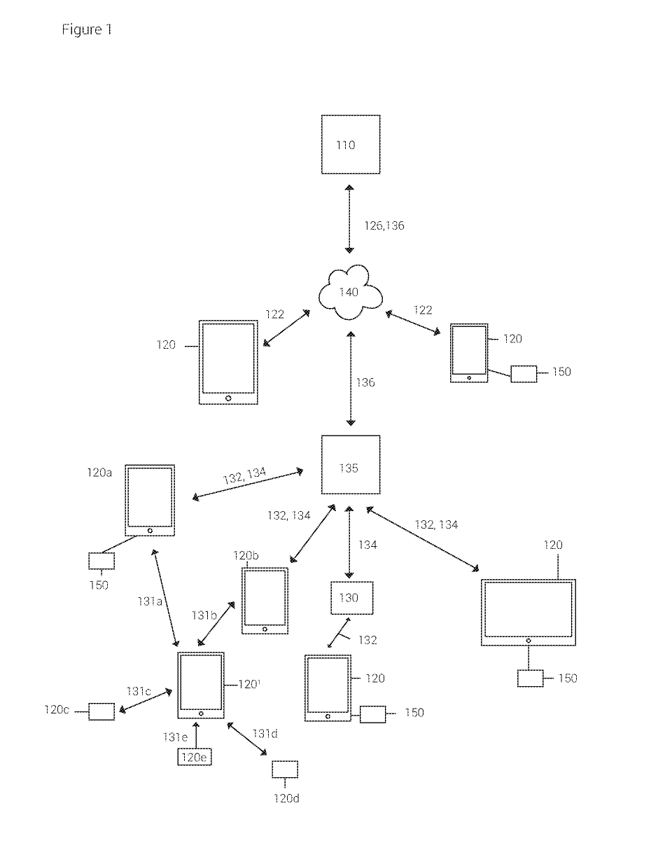

As an overview, an example embodiment of a system (e.g., system 100) for use in determining a location or location status of one or more computing devices is illustrated in FIG. 1. The system (e.g., system 100) may comprise and/or be configurable to communicate with a processor (e.g., processor 110).

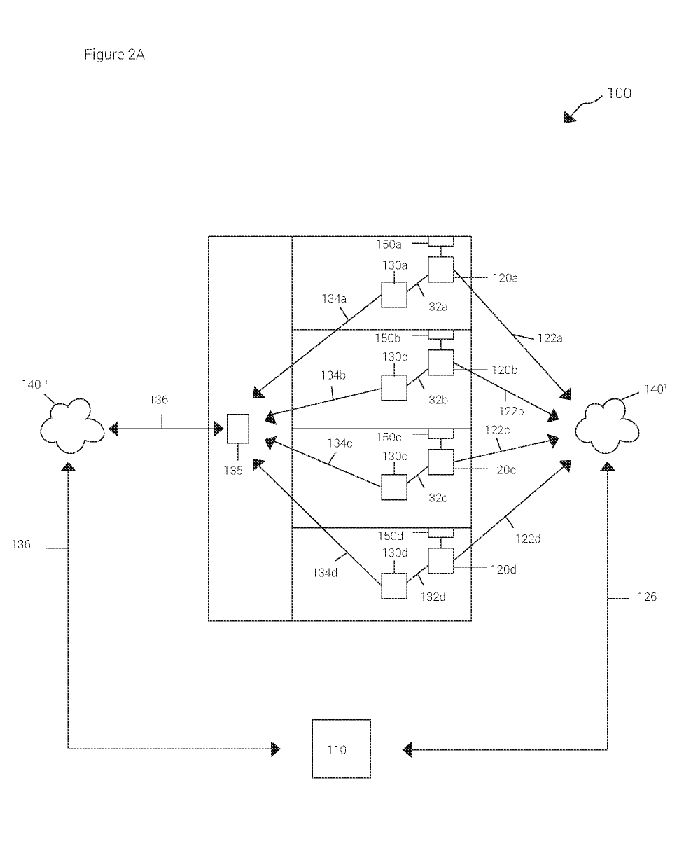

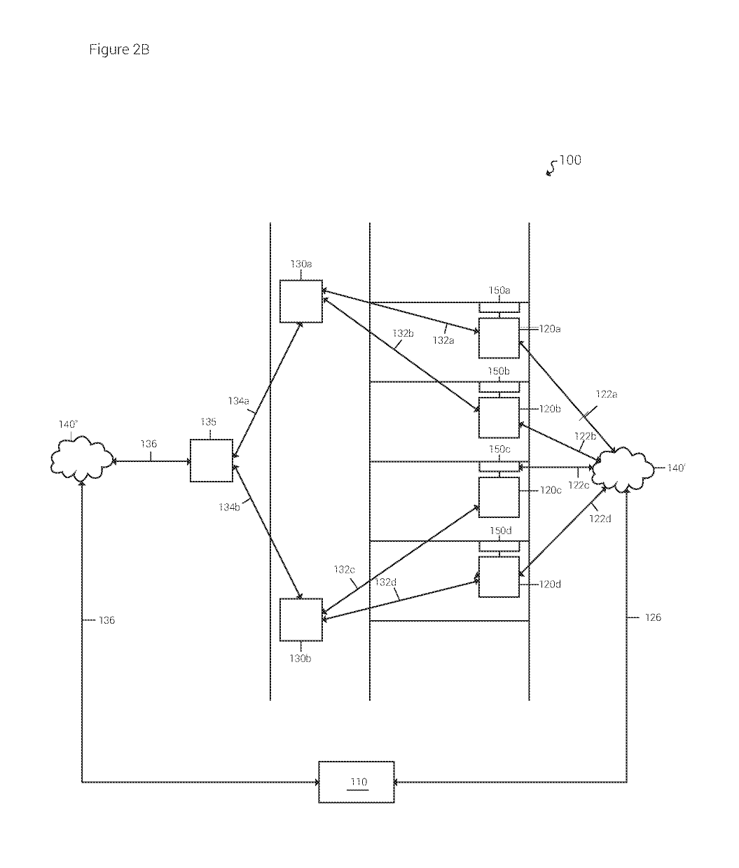

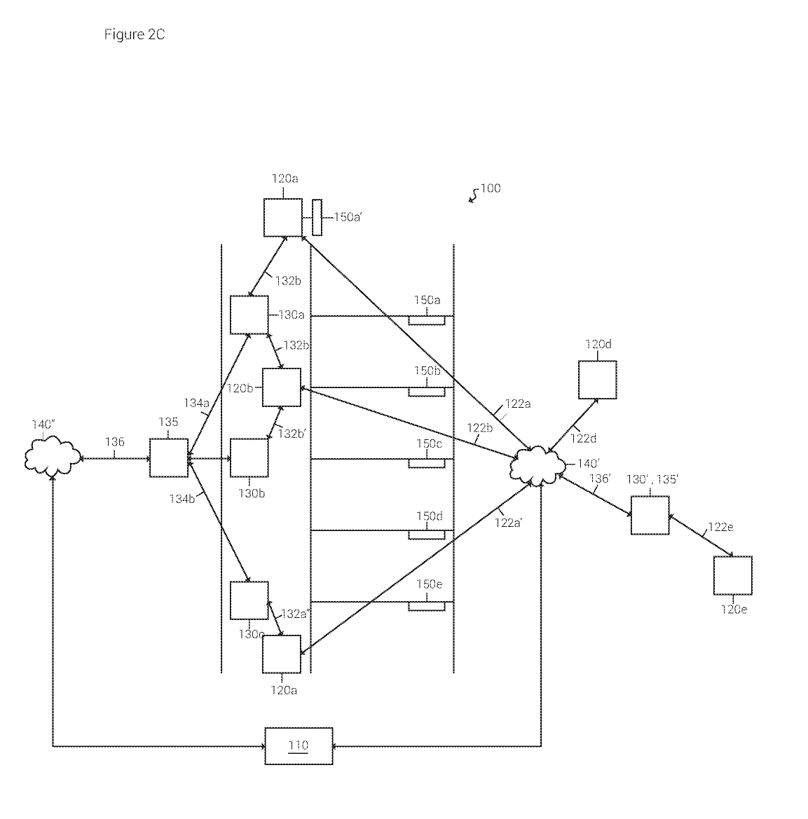

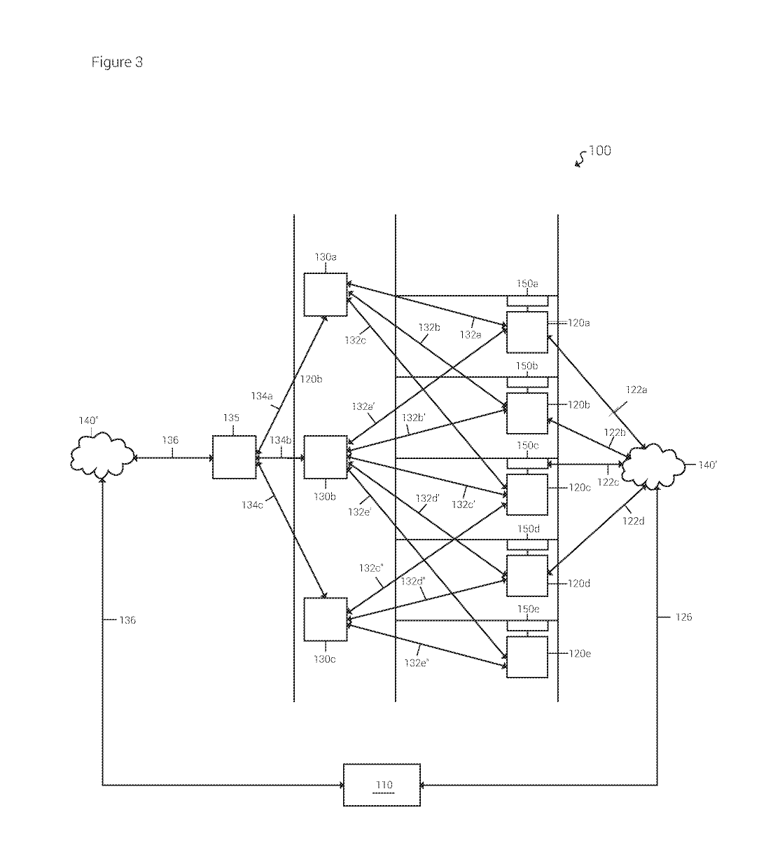

In an example embodiment, the system (e.g., system 100) may also include and/or be configurable to communicate with one or more computing devices (e.g., computing devices 120, 120′, 120a, 120b, 120c, 120d, and/or 120e illustrated in FIG. 1; computing devices 120a, 120b, 120c, and/or 120d illustrated in FIG. 2A and FIG. 2B; and/or computing devices 120a, 120b, 120c, 120d, and/or 120e illustrated in FIG. 2C and FIG. 3). As used in the present disclosure, when applicable, a reference to a “computing device,” “computing device 120,” and/or one or more of the computing devices 120′, 120a, 120b, 120c, 120d, and/or 120e may also refer to, apply to, and/or include one or more of the computing devices 120, 120′, 120a, 120b, 120c, 120d, and/or 120e described in the present disclosure and/or illustrated in the accompanying figures without departing from the teachings of the present disclosure.

The system (e.g., system 100) may also include and/or be configurable to communicate with one or more communication sources (e.g., transmitting devices 130 and/or 135 illustrated in FIG. 1; transmitting devices 130a, 130b, 130c, and/or 130d illustrated in FIG. 2A; transmitting devices 130a and/or 130b illustrated in FIG. 2B; transmitting devices 130a, 130b, and/or 130c illustrated in FIG. 2C; and/or transmitting devices 130a, 130b, 130c, 130′, 135, and/or 135′ illustrated in FIG. 3) (hereinafter also referred to as a “communication device” or “transmitting device”). As used in the present disclosure, when applicable, a reference to a “communication device,” “transmitting device,” “transmitting device 130,” “transmitting device 135,” and/or one or more of the transmitting devices 130′, 130a, 130b, 130c, 130d, and/or 135′ may also refer to, apply to, and/or include one or more of the transmitting devices 130, 130′, 130a, 130b, 130c, 130d, 135, and/or 135′ and/or one or more of the computing devices described in the present disclosure and/or illustrated in the accompanying figures without departing from the teachings of the present disclosure. For example, as further described in the present disclosure, a computing device (e.g., computing device 120) may also be, represent, include, and/or perform some or all of the operations of a communication device (e.g., transmitting device 130 and/or 135), such as in example embodiments where location determination is performed via wireless signals transmitted from such computing devices.

The system (e.g., system 100) may also include and/or be configurable to communicate with one or more networks (e.g., network 140 illustrated in FIG. 1 and/or network 140′ and/or 140″ illustrated in FIGS. 2A-C and 3) and/or the cloud.

The system (e.g., system 100) may also include and/or be configurable to communicate with one or more energy sources (e.g., external energy source 150 illustrated in FIG. 1; external energy source 150a, 150b, 150c, and/or 150d illustrated in FIGS. 2A-B; external energy source 150a, 150a′, 150b, 150c, 150d, and/or 150e illustrated in FIGS. 2C and 3; a dedicated external energy source for the computing device, such as a docking station, or the like; a computing device providing DC power via a USB connector and cable (not shown); and/or a portable power supply, such as a power bank 150a′, or the like, as illustrated in FIG. 3). As used in the present disclosure, when applicable, a reference to an “external energy source,” “external energy source 150,” and/or one or more of the external energy sources 150a, 150a′, 150b, 150c, and/or 150d may also refer to, apply to, and/or include one or more of the external energy sources 150, 150a, 150a′, 150b, 150c, and/or 150d described above and in the present disclosure and/or illustrated in the accompanying figures without departing from the teachings of the present disclosure.

Example embodiments of the system (e.g., system 100) may include or not include one or more of the elements described above and in the present disclosure, may include additional elements, may be formed and/or used in different sequences, actions, combinations, and/or configurations, and/or one or more of the elements (and/or elements of elements) may be combinable into a single element or divided into two or more elements. Communications using technologies other than local area networks (e.g., WLAN routers, Wi-Fi routers, Wi-Fi access points (WAP), computing devices configurable to function as a Wi-Fi access point such as a personal hot spot, and Li-Fi routers), Bluetooth, NFC, powerline networks, repeaters and/or regenerators (e.g., Wi-Fi repeaters/regenerators), network access points (e.g., WAP and personal hot spots), and mobile computing devices (e.g., computing device 120) are also contemplated in example embodiments without departing from the teachings of the present disclosure. These systems (e.g., system 100), and elements thereof, will now be further explained with reference to the accompanying figures.

Computing Device (e.g., Computing Device 120).

As illustrated in at least FIG. 1, FIGS. 2A-C, and FIG. 3, the system (e.g., system 100) may include one or more computing devices (e.g., computing device 120).

The computing device (e.g., computing device 120) may be any device, computing device, mobile computing device, processor, controller, or the like, configurable or configured to perform a processing of information, wireless communications, and/or any of the other actions described above and in the present disclosure. For example, the computing device (e.g., computing device 120) may be configurable to perform wireless communications through 3G networks, 4G networks, 4G LTE networks, or the like, such as via a SIM card installed in the computing device (e.g., computing device 120), or the like. In addition to or in replacement, the computing device (e.g., computing device 120) may be configurable to perform wireless communications via WLANs, such as Wi-Fi networks and Li-Fi networks, and/or via other forms, such as Bluetooth, NFC, and other forms of short range wireless signals, when the computing device (e.g., computing device 120) is within range of (i.e., capable of receiving) such wireless signals. One or more of the aforementioned wireless communications may be between example embodiments of the computing device (e.g., computing device 120), one or more processors (e.g., processor 110), one or more communication devices (e.g., transmitting devices 130 and/or 135), one or more other computing devices (e.g., computing device 120), and/or one or more networks (e.g., network 140).

In an example embodiment, the computing device (e.g., computing device 120) may be any computing device, such as a smart phone device issued by an employer to an employee for use in an office setting (e.g., office building) and other locations/settings. The computing device (e.g., computing device 120) may also be any computing device, such as a tablet issued by a university (or other educational institution) to a student for use in the university (or other educational institution) campus or dormitory (e.g., in one or more buildings, including multi-floor buildings) and other locations. The computing device (e.g., computing device 120) may also be any computing device, such as a smart phone device issued by a hotel operator to a hotel guest for the hotel guest to use during their stay at the hotel, and such use may be in the hotel and other locations/settings. Other example situations, applications, and uses are contemplated without departing from the teachings of the present disclosure. Example embodiments, including those illustrated in FIGS. 1, 2A-C, and 3, may be applicable for use in one or more of the example situations, applications, and uses described above and in the present disclosure, as well as for other situations.

The computing device (e.g., computing device 120) may include an energy source (e.g., a re-chargeable battery) (not shown). The energy source of the computing device (e.g., computing device 120) may be configurable to be connected, either wirelessly or via wires, to an external energy source (e.g., external energy source 150). The external energy source may be an AC electrical outlet and/or dedicated AC docking station (e.g., external energy source 150a, 150b, 150c, and 150d illustrated in FIGS. 2A-B and external energy source 150a, 150b, 150c, 150d, and 150e illustrated in FIGS. 2C and 3), or the like, operable to provide power to (i.e., charge) the energy source of the computing device (e.g., computing device 120). The external energy source (e.g., external energy source 150) may also be another computing device, such as a laptop or desktop computer, providing DC power via a USB connector and cable (not shown), or the like. The external energy source (e.g., external energy source 150) may also be a portable power supply, such as a power bank 150a′, or the like, as illustrated in FIG. 3.

Once the energy source of the computing device (e.g., computing device 120) is connected to the external energy source (e.g., external energy source 150), the energy source of the computing device (e.g., computing device 120) may be configurable to be charged by the external energy source (e.g., external energy source 150). When fully charged, the charge level of the energy source of the computing device (e.g., computing device 120) may continue to be maintained or closely maintained (i.e., continue to be charged) when the energy source remains connected to the external energy source (e.g., external energy source 150). In some embodiments, when fully charged, the external energy source (e.g., external energy source 150) connected to the energy source of the computing device (e.g., computing device 120) may stop charging the energy source altogether, such as in situations where the external energy source (e.g., external energy source 150) is a portable power source, power bank, or the like.

The computing device (e.g., computing device 120) may also have installed an operating system, such as a version of the Android operating system, a version of the iOS operating system, etc., configurable or configured to enable a processor of the computing device (e.g., computing device 120) to perform, either in part or in whole, directly or indirectly, one or more of the actions described above and in the present disclosure. The computing device (e.g., computing device 120) may also include one or more applications installed (e.g., mobile applications, widgets, etc.) which, when executed by a processor of the computing device (e.g., computing device 120), is configurable or configured to perform, either in part or in whole, directly or indirectly, one or more of the actions described above and in the present disclosure. The computing device (e.g., computing device 120) may also be configurable or configured to perform, either in part or in whole, directly or indirectly, one or more of the actions described above and in the present disclosure via cloud computing, or the like. The one or more actions described above and in the present disclosure may also be performable, either in part or in whole, directly or indirectly, by more than one computing device (e.g., computing device 120), and such computing devices (e.g., computing device 120) may be configurable or configured to communicate in any network topology, including, but not limited to, a mesh network, ring network, star network, point-to-point network, hybrid network, etc. FIG. 1 is a partial illustration of a non-limiting example of computing devices (e.g., computing devices 120′, 120a, 120b, 120c, 120d, and 120e) configured in a mesh network.

In an example embodiment, the computing device (e.g., computing device 120) may be configurable or configured to assess, determine, transmit, and/or make available (e.g., transmit and/or make available to the processor, one or more other computing devices, and/or one or more communication devices) information pertaining to a current state of the computing device (e.g., computing device 120). Such assessing, determining, transmitting, and/or making available of information pertaining to the current state of the computing device (e.g., computing device 120) may be performable, either in part or in whole, directly or indirectly, by the operating system of the computing device (e.g., computing device 120), one or more application installed in the computing device (e.g., computing device 120), cloud computing, and/or one or more other computing devices (e.g., computing device 120) communicating with the computing device (e.g., computing device 120) in a mesh network, ring network, point-to-point network, etc. For example, as illustrated in FIG. 1, computing device 120a may be configurable or configured to assess and/or determine the current state of computing device 120a, and transmit the current state to the processor 110. As another example, as illustrated in FIG. 1, computing device 120b may be configurable or configured to make available information to the processor 110 to enable the processor 110 to assess and/or determine the current state of the computing device 120b. In yet another example, as illustrated in FIG. 1, computing device 120′ may be configurable or configured to assess and/or determine the current state of computing device 120′, and transmit the current state to computing device 120a, 120b, 120c, 120d, and/or 120e and/or processor 110. In yet another example, as illustrated in FIG. 1, computing device 120′ may be configurable or configured to make available information to computing device 120a to enable computing device 120a to assess and/or determine the current state of computing device 120′. In yet another example, as illustrated in FIG. 1, computing device 120d may be configurable or configured to make available information pertaining to computing device 120d to computing device 120′, computing device 120′ may be configurable to make available information pertaining to computing device 120d to computing device 120a, and computing device 120a may be configurable or configured to make available information pertaining to computing device 120d to processor 110 to enable processor 110 to assess and/or determine the current state of computing device 120d, 120′, and/or 120a. Other examples are contemplated without departing from the teachings of the present disclosure.

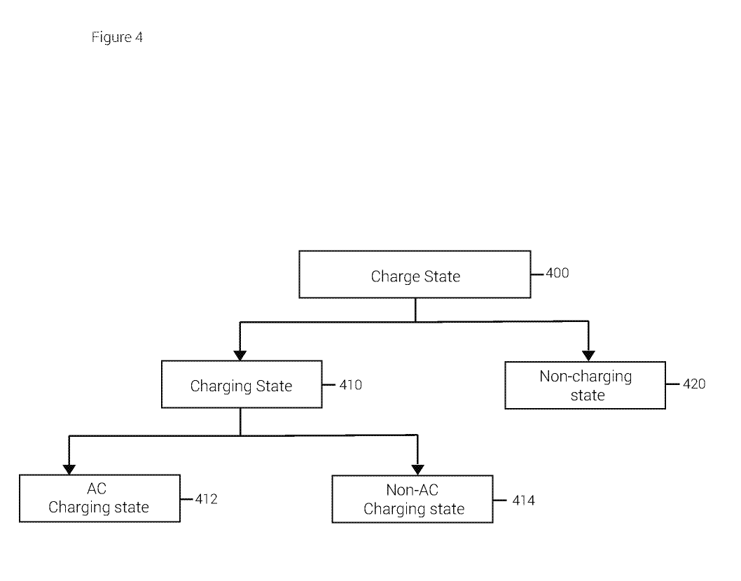

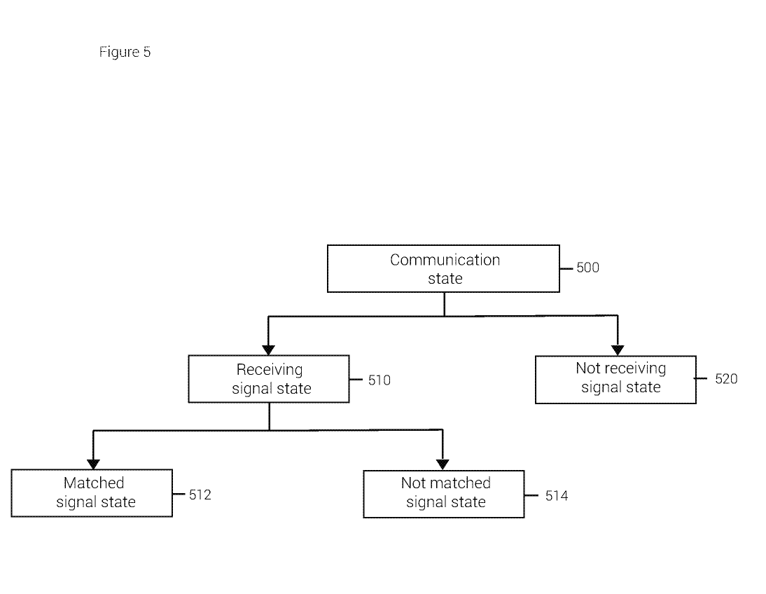

The current state of the computing device (e.g., computing device 120) may be any state, such as a charge state (e.g., charge state illustrated in FIG. 4) of the computing device (e.g., computing device 120) and/or communication state (e.g., communication state illustrated in FIG. 5) of the computing device (e.g., computing device 120). In respect to the charge state (e.g., charge state 400), the charge state (e.g., charge state 400) may be a state indicative of whether or not the energy source of the computing device (e.g., computing device 120) is connected to and/or being charged by an external energy source (e.g., external energy source 150). The charge state (e.g., charge state 400) may, in turn, be in a charging state (e.g., charging state 410) or a non-charging state (e.g., non-charging state 420), as illustrated in FIG. 4 and further described below and in the present disclosure. In respect to the communication state (e.g., communication state 500) of the computing device (e.g., computing device 120), the communication state (e.g., communication state 500) may be a state indicative of whether or not the computing device (e.g., computing device 120) is receiving wireless signals. The communication state (e.g., communication state 500) may, in turn, be in a receiving signal state (e.g., receiving signal state 510) or a not receiving signal state (e.g., not receiving signal state 520), as illustrated in FIG. 5 and further described below and in the present disclosure.

The computing device (e.g., computing device 120) may be configurable or configured to directly assess and/or determine, either in part or in whole, the current state of the computing device (e.g., computing device 120). For example, the computing device (e.g., computing device 120) may be configured in such a way as to include computer-implementable instructions (e.g., the operating system, mobile application, widget, etc.) executable by the computing device (e.g., computing device 120) to determine the current state of the computing device (e.g., computing device 120). Such determining may be performed upon receiving information, instructions, and/or commands from the processor (e.g., processor 110) and/or another computing device (e.g., computing device 120), periodically, based on a predetermined schedule, continuously, and/or based on an event occurring (e.g., when an employee is scheduled or required to be at his/her office or a meeting, when a student is scheduled or required to be in a lecture or taking an examination, and/or when a hotel guest has checked in or out of the hotel).

Alternatively or in addition, the computing device (e.g., computing device 120) may be configurable or configured to transmit information, such as to the processor (e.g., processor 110) and/or another computing device (e.g., computing device 120), so as to enable an assessment and/or determination of the current state of the computing device (e.g., computing device 120), such as by the processor (e.g., processor 110) and/or another computing device (e.g., computing device 120). Such transmitting of information may be performed upon receiving information, instructions, and/or commands from the processor (e.g., processor 110) and/or another computing device (e.g., computing device 120), periodically, based on a predetermined schedule, continuously, and/or based on an event occurring (e.g., when an employee is scheduled or required to be at his/her office or a meeting, when a student is scheduled or required to be in a lecture or taking an examination, and/or when a hotel guest has checked in or out of the hotel).

Alternatively or in addition, the computing device (e.g., computing device 120) may be configurable or configured to make available and/or allow access to information, such as to the processor (e.g., processor 110) and/or another computing device (e.g., computing device 120), so as to enable an assessment and/or determination of the current state of the computing device (e.g., computing device 120), such as by the processor (e.g., processor 110) and/or another computing device (e.g., computing device 120). Such making available and/or allowing access to information may be performed upon receiving instructions from the processor (e.g., processor 110) and/or another computing device (e.g., computing device 120), periodically, based on a predetermined schedule, continuously, and/or based on an event occurring (e.g., when an employee is scheduled or required to be at his/her office or a meeting, when a student is scheduled or required to be in a lecture or taking an examination, and/or when a hotel guest has checked in or out of the hotel).

The current state of the computing device (e.g., computing device 120), including the charge state (e.g., charge state 400) and the communication state (e.g., communication state 500), are further described below and in the present disclosure.

(1) The Charge State (e.g., Charge State 400).

As illustrated in FIG. 4, the charge state (e.g., charge state 400) of the computing device (e.g., computing device 120) may be determined to be in (a) a non-charging state (e.g., non-charging state 420), or (b) charging state (e.g., charge state 410). If the charge state (e.g., charge state 400) of the computing device (e.g., computing device 120) is determined to be in the charging state (e.g., charging state 410), the charge state (e.g., charge state 400) may be further determined to be in (i) an alternating current (AC) charging state (e.g., AC charging state 412), (ii) a non-alternating current (non-AC) charging state (e.g., non-AC charging state 414), (iii) a high powered charging state, and/or (iv) a low powered charging state. These states are further described below and in the present disclosure.

(1)(a) The Non-Charging State (e.g., Non-Charging State 420).

In an example embodiment, a current state and/or charge state (e.g., charge state 400) of the computing device (e.g., computing device 120) may be a non-charging state (e.g., non-charging state 420). The non-charging state (e.g., non-charging state 420) of the computing device (e.g., computing device 120) may be a state in which a determination is made by the computing device (e.g., computing device 120), processor (e.g., processor 110), and/or another computing device that the energy source of the computing device (e.g., computing device 120) is not connected to and/or not being charged by an external energy source (e.g., external energy source 150). For example, the non-charging state (e.g., non-charging state 420) may be a state in which a determination is made that the energy source of the computing device (e.g., computing device 120) is not connected to an external energy source (e.g., external energy source 150). In some examples, the non-charging state (e.g., non-charging state 420) may be a state in which a determination is made that the energy source of the computing device (e.g., computing device 120) is connected to, but not being charged by, an external energy source (e.g., when the external energy source 150 and/or cable connecting the external energy source 150 to the computing device is non-compliant, non-compatible, insufficient, and/or damaged, or when the external energy source 150 has stopped performing the charging). Other examples are contemplated without departing from the teachings of the present disclosure. As described above and in the present disclosure, an assessment and/or determination of whether or not the computing device (e.g., computing device 120) is in the non-charging state (e.g., non-charging state 420) (or other state) may be performed directly by the computing device (e.g., computing device 120) and/or remotely by the processor (e.g., processor 110) and/or another computing device.

(1)(b) The Charging State (e.g., Charging State 410).

The current state and/or charge state (e.g., charge state 400) of the computing device (e.g., computing device 120) may also be a charging state (e.g., charging state 410) in example embodiments. The charging state (e.g., charging state 410) may be a charge state (e.g., charge state 400) other than the non-charging state (e.g., non-charging state 420), and vice versa. The charging state (e.g., charging state 410) of the computing device (e.g., computing device 120) may be a state in which a determination is made by the computing device (e.g., computing device 120), processor (e.g., processor 110), and/or another computing device that the energy source of the computing device (e.g., computing device 120) is connected to and/or being charged by an external energy source (e.g., external energy source 150). For example, the charging state (e.g., charging state 410) may be a state in which a determination is made that the energy source of the computing device (e.g., computing device 120) is connected to and being charged by an external energy source (e.g., external energy source 150). As another example, the charging state (e.g., charging state 410) may be a state in which a determination is made that the energy source of the computing device (e.g., computing device 120) is fully charged and still connected to an external energy source (e.g., the external energy source 150 continues to maintain the fully charged status of the energy source of the computing device). Other examples are contemplated without departing from the teachings of the present disclosure. As described above and in the present disclosure, an assessment and/or determination of whether or not the computing device (e.g., computing device 120) is in the charging state (e.g., charging state 410) (or other state) may be performed directly by the computing device (e.g., computing device 120) and/or remotely by the processor (e.g., processor 110) and/or another computing device.

The charging state (e.g., charging state 410) may, in turn, be determined to be (i) an alternating current (AC) charging state (e.g., AC charging state 412), or (ii) a non-alternating current (non-AC) charging state (e.g., non-AC charging state 414), as further described below and in the present disclosure.

(1)(b)(i) The AC Charging State (e.g., AC Charging State 412).

In an example embodiment, the charging state (e.g., charging state 410) may be an AC charging state (e.g., AC charging state 412). The AC charging state (e.g., AC charging state 412) of the computing device (e.g., computing device 120) may be a state in which a determination is made by the computing device (e.g., computing device 120), processor (e.g., processor 110), and/or another computing device that the energy source of the computing device (e.g., computing device 120) is connected to and/or being charged by an alternating current (AC) external energy source (e.g., external energy source 150a, 150b, 150c, and 150d illustrated in FIGS. 2A-B and external energy source 150a, 150b, 150c, 150d, and 150e illustrated in FIGS. 2C and 3). For example, the AC charging state (e.g., AC charging state 412) may be a state in which a determination is made that the energy source of the computing device (e.g., computing device 120) is connected to and being charged by an AC electrical outlet, such as a typical wall outlet found in offices, homes, etc., or a dedicated AC docking station (which may be a wired and/or wireless docking station and may provide power to the energy source of the computing device (e.g., computing device 120) via wires and/or wirelessly). As another example, the AC charging state (e.g., AC charging state 412) may be a state in which a determination is made that the energy source of the computing device (e.g., computing device 120) is fully charged and still connected to an AC external energy source (e.g., the AC external energy source continues to maintain the fully charged status of the energy source of the computing device (e.g., computing device 120)). Other examples are contemplated without departing from the teachings of the present disclosure. As described above and in the present disclosure, an assessment and/or determination of whether or not the computing device (e.g., computing device 120) is in the AC charging state (e.g., AC charging state 412) (or other state) may be performed directly by the computing device (e.g., computing device 120) and/or remotely by the processor (e.g., processor 110) and/or another computing device.

(1)(b)(ii) The Non-AC Charging State (e.g., Non-AC Charging State 414).

The charging state (e.g., charging state 410) may be a non-alternating current (non-AC) charging state (e.g., non-AC charging state 414) in example embodiments. The non-AC charging state (e.g., non-AC charging state 414) may be a charging state (e.g., charging state 410) other than the AC charging state (e.g., AC charging state 412), and vice versa. The non-AC charging state (e.g., non-AC charging state 414) of the computing device (e.g., computing device 120) may be a state in which a determination is made by the computing device (e.g., computing device 120), processor (e.g., processor 110), and/or another computing device that the energy source of the computing device (e.g., computing device) is connected to and/or being charged by a non-alternating current (non-AC) external energy source (e.g., external energy source 150a′). For example, the non-AC charging state (e.g., non-AC charging state 414) may be a state in which a determination is made that the energy source of the computing device (e.g., computing device 120) is connected to and being charged by an energy source providing non-AC or direct current (DC) power, such as a portable power source or power bank (e.g., external energy source 150a′). As another example, the non-AC charging state (e.g., non-AC charging state 414) may be a state in which a determination is made that the energy source of the computing device (e.g., computing device 120) is fully charged and still connected to a non-AC external energy source (e.g., the non-AC external energy source 150a′ continues to maintain the fully charged status of the energy source of the computing device). Other examples are contemplated without departing from the teachings of the present disclosure. As described above and in the present disclosure, an assessment and/or determination of whether or not the computing device (e.g., computing device 120) is in the non-AC charging state (e.g., non-AC charging state 414) (or other state) may be performed directly by the computing device (e.g., computing device 120) and/or remotely by the processor (e.g., processor 110) and/or another computing device.

(1)(b)(iii) The High Powered Charging State.

In an example embodiment, the charging state (e.g., charging state 410) may be a high powered charging state. The high powered charging state of the computing device (e.g., computing device 120) may be a state in which a determination is made by the computing device (e.g., computing device 120), processor (e.g., processor 110), and/or another computing device that the energy source of the computing device (e.g., computing device 120) is connected to and/or being charged by an alternating current (AC) external energy source (e.g., external energy source 150a, 150b, 150c, and 150d illustrated in FIGS. 2A-B and external energy source 150a, 150b, 150c, 150d, and 150e illustrated in FIGS. 2C and 3) and/or other form of high powered external energy source. For example, the high powered charging state may be a state in which a determination is made that the energy source of the computing device (e.g., computing device 120) is connected to and being charged by an AC or non-AC electrical outlet, such as a typical wall outlet found in offices, homes, etc., or a dedicated docking station. As another example, the high powered charging state may be a state in which a determination is made that the energy source of the computing device (e.g., computing device 120) is fully charged and still connected to a high powered energy source (e.g., the high powered energy source continues to maintain the fully charged status of the energy source of the computing device (e.g., computing device 120)). Other examples are contemplated without departing from the teachings of the present disclosure. As described above and in the present disclosure, an assessment and/or determination of whether or not the computing device (e.g., computing device 120) is in the high powered charging state (or other state) may be performed directly by the computing device (e.g., computing device 120) and/or remotely by the processor (e.g., processor 110) and/or another computing device.

(1)(b)(iv) The Low Powered Charging State.

The charging state (e.g., charging state 410) may be a low powered charging state in example embodiments. The low powered charging state may be a charging state other than the high powered charging state, and vice versa. The low powered charging state of the computing device (e.g., computing device 120) may be a state in which a determination is made by the computing device (e.g., computing device 120), processor (e.g., processor 110), and/or another computing device that the energy source of the computing device (e.g., computing device) is connected to and/or being charged by a low powered and/or non-alternating current (non-AC) external energy source. For example, the low powered charging state may be a state in which a determination is made that the energy source of the computing device (e.g., computing device 120) is connected to and being charged by a low powered energy source providing non-AC, direct current (DC), and/or low power, such as a portable power source or power bank. As another example, the low powered charging state may be a state in which a determination is made that the energy source of the computing device (e.g., computing device 120) is fully charged and still connected to a low powered energy source (e.g., the low powered energy source continues to maintain the fully charged status of the energy source of the computing device). Other examples are contemplated without departing from the teachings of the present disclosure. As described above and in the present disclosure, an assessment and/or determination of whether or not the computing device (e.g., computing device 120) is in the low powered charging state (or other state) may be performed directly by the computing device (e.g., computing device 120) and/or remotely by the processor (e.g., processor 110) and/or another computing device.

(2) The Communication State (e.g., Communication State 500).

As illustrated in FIG. 5, the communication state (e.g., communication state 500) of the computing device (e.g., computing device 120) may be determined to be (a) a receiving signal state (e.g., receiving signal state 510), or (b) a not receiving signal state (e.g., not receiving signal state 520). In an example embodiment, a determination of whether the communication state (e.g., communication state 500) is a receiving signal state (e.g., receiving signal state 510) or not receiving signal state (e.g., not receiving signal state 520) may be based on, among other things, one or more wireless signals received and/or being received by the computing device (e.g., computing device 120). It is to be understood in the present disclosure that such one or more wireless signals received and/or being received (collectively “wireless signals received” or “received wireless signals”) may be transmitted by one or more communication devices (e.g., transmitting device 130 and/or 135 and/or computing device 120). For example, when determining a location and/or location status of computing device 120a (as illustrated in FIG. 2A), the determination may be based on the received wireless signal 132a. Similarly, when determining a location and/or location status of computing devices 120b, 120c, and 120d (as illustrated in FIG. 2A), the determination may be based on the received wireless signals 132b, 132c, and 132d, respectively. As another example, when determining a location and/or location status of computing device 120a (as illustrated in FIG. 2B), the determination may be based on the received wireless signal 132a. Similarly, when determining a location and/or location status of computing devices 120b, 120c, and 120d (as illustrated in FIG. 2B), the determination may be based on the received wireless signals 132b, 132c, and 132d, respectively. As another example, when determining a location and/or location status of computing device 120a (as illustrated in FIG. 2C), the determination may be based on the received wireless signals 132a and 132a′. Similarly, when determining a location and/or location status of computing device 120b (as illustrated in FIG. 2C), the determination may be based on the received wireless signals 132b and 132b′. Similarly, when determining a location and/or location status of computing device 120c (as illustrated in FIG. 2C), the determination may be based on the received wireless signals 132c, 132c′, and 132c″. Similarly, when determining a location and/or location status of computing device 120d (as illustrated in FIG. 2C), the determination may be based on the received wireless signals 132d′ and 132d″. Similarly, when determining a location and/or location status of computing device 120e (as illustrated in FIG. 2C), the determination may be based on the received wireless signals 132e′ and 132e″. As another example, when determining a location and/or location status of computing device 120a (as illustrated in FIG. 2A), the determination may be based on the received wireless signal 138a. Similarly, when determining a location and/or location status of computing device 120b (as illustrated in FIG. 2A), the determination may be based on the received wireless signals 138a and 138b. Similarly, when determining a location and/or location status of computing device 120c (as illustrated in FIG. 2A), the determination may be based on the received wireless signals 138b and 138c. Similarly, when determining a location and/or location status of computing device 120d (as illustrated in FIG. 2A), the determination may be based on the received wireless signal 138c.

If the communication state (e.g., communication state 500) of the computing device (e.g., computing device 120) is determined to be the receiving signal state (e.g., receiving signal state 510), the communication state (e.g., communication state 500) may be further determined to be (i) a matched signal state (e.g., matched signal state 512), or (ii) a not matched signal state (e.g., not matched signal state 514). These states are further described below and in the present disclosure.

(2)(a) The not Receiving Signal State (e.g., not Receiving Signal State 520).

In an example embodiment, a current state and/or communication state (e.g., communication state 500) of the computing device (e.g., computing device 120) may be a not receiving signal state (e.g., not receiving signal state 520). For example, the not receiving signal state (e.g., not receiving signal state 520) may be a state in which the computing device (e.g., computing device 120) is not receiving any wireless signals. As another example, the not receiving signal state (e.g., not receiving signal state 520) may be a state in which the computing device (e.g., computing device 120) is not receiving wireless signals of WLANs, such as Wi-Fi networks and Li-Fi networks, and/or via other forms, such as Bluetooth, NFC, and other forms of short range wireless signals. As a more specific example, the not receiving signal state (e.g., not receiving signal state 520) may be a state in which the computing device (e.g., computing device 120) is not receiving wireless signals of a Wi-Fi network transmitted by a Wi-Fi router, WAP, and/or another computing device (e.g., computing device 120 configurable or configured to function as a WLAN hotspot (e.g., Wi-Fi hotspot or personal hotspot)). As another example, the not receiving signal state (e.g., not receiving signal state 520) may be a state in which the computing device (e.g., computing device 120) is receiving wireless signals through 3G networks, 4G networks, 4G LTE networks, or the like, such as via a SIM card, or the like, but not receiving any wireless signals from WLANs. In some examples, the not receiving signal state (e.g., not receiving signal state 520) may be a state in which the computing device (e.g., computing device 120) is (i) receiving wireless signals through 3G networks, 4G networks, 4G LTE networks, or the like, such as via a SIM card, or the like; and (ii) receiving wireless signals of a Wi-Fi network transmitted by a Wi-Fi router, WAP, and/or another computing device (e.g., computing device 120), but such wireless signals received from the WLANs are not signals that were assigned to, pre-associated with, and/or pre-determined for the computing device (e.g., computing device 120). In some examples, the not receiving signal state (e.g., not receiving signal state 520) may be a state in which the computing device (e.g., computing device 120) is (i) receiving wireless signals through 3G networks, 4G networks, 4G LTE networks, or the like, such as via a SIM card, or the like; and (ii) receiving wireless signals of a Wi-Fi network transmitted by a Wi-Fi router, WAP, and/or another computing device (e.g., computing device 120), but the identity of the communication devices (i.e., Wi-Fi router, WAP, and/or computing device (e.g., computing device 120)) transmitting such wireless signals are not communication devices that were assigned to, pre-associated with, and/or pre-determined for the computing device (e.g., computing device 120). Other examples are contemplated without departing from the teachings of the present disclosure. As described above and in the present disclosure, an assessment and/or determination of whether or not the computing device (e.g., computing device 120) is in the not receiving signal state (e.g., not receiving signal state 520) (or other state) may be performed directly by the computing device (e.g., computing device 120) and/or remotely by the processor (e.g., processor 110) and/or one or more other computing devices.

(2)(b) The Receiving Signal State (e.g., Receiving Signal State 510).

As described above, the current state and/or communication state (e.g., communication state 500) of the computing device (e.g., computing device 120) may be a receiving signal state (e.g., receiving signal state 510). The receiving signal state (e.g., receiving signal state 510) may be a communication state (e.g., communication state 500) other than the not receiving signal state (e.g., not receiving signal state 520), and vice versa. For example, the receiving signal state (e.g., receiving signal state 510) may be a state in which the computing device (e.g., computing device 120) is receiving one or more wireless signals. As another example, the receiving signal state (e.g., receiving signal state 510) may be a state in which the computing device (e.g., computing device 120) is receiving wireless signals via WLANs, such as Wi-Fi networks and Li-Fi networks, and/or from other signal forms, such as Bluetooth, NFC, and other forms of short range wireless signals. In yet another example, the receiving signal state (e.g., receiving signal state 510) may be a state in which the computing device (e.g., computing device 120) is receiving wireless signals from one or more communication devices (e.g., transmitting device 130 and/or 135 and/or computing device 120) that form part of a WLAN, such as Wi-Fi networks and Li-Fi networks, and/or from one or more communication devices (e.g., transmitting devices 130 and/or 135 and/or computing device 120) that communicate other signal forms, such as Bluetooth, NFC, and other forms of short range wireless signals. As a more specific example, the receiving signal state (e.g., receiving signal state 510) may be a state in which the computing device (e.g., computing device 120) is receiving wireless signals of a Wi-Fi network transmitted by a Wi-Fi router, WAP, and/or another computing device (e.g., computing device 120). As another example, the receiving signal state (e.g., receiving signal state 510) may be a state in which the computing device (e.g., computing device 120) is receiving wireless signals through 3G networks, 4G networks, 4G LTE networks, or the like, such as via a SIM card, or the like, and also receiving wireless signals from WLANs and/or via other forms, such as Bluetooth, NFC, and other forms of short range wireless signals. In yet another example, the receiving signal state (e.g., receiving signal state 510) may be a state in which the computing device (e.g., computing device 120) is (i) receiving wireless signals through 3G networks, 4G networks, 4G LTE networks, or the like, such as via a SIM card, or the like; and (ii) receiving wireless signals from WLANs and/or via other forms, such as Bluetooth, NFC, and other forms of short range wireless signals, and such wireless signals received are signals that were assigned to, pre-associated with, and/or pre-determined for the computing device (e.g., computing device 120). In yet another example, the receiving signal state (e.g., receiving signal state 510) may be a state in which the computing device (e.g., computing device 120) is (i) receiving wireless signals through 3G networks, 4G networks, 4G LTE networks, or the like, such as via a SIM card, or the like; and (ii) receiving wireless signals of a Wi-Fi network transmitted by a Wi-Fi router, WAP, and/or another computing device (e.g., computing device 120) functioning as a WLAN hotspot (e.g., Wi-Fi hotspot or personal hotspot), and the identity of the communication devices (i.e., Wi-Fi router, WAP, and/or computing device (e.g., computing device 120)) transmitting such wireless signals are communication devices that were assigned to, pre-associated with, and/or pre-determined for the computing device (e.g., computing device 120). Other examples are contemplated without departing from the teachings of the present disclosure.

In an example embodiment, an assessment and/or determination by the computing device (e.g., computing device 120), processor (e.g., processor 110), and/or other computing device of a number/quantity of received wireless signals may be performed. For example, as illustrated in FIG. 2C, the computing device 120a may determine that it is receiving two wireless signals from communication devices (e.g., transmitting device 130 and/or 135 and/or computing device 120), namely wireless signal 132a from transmitting device 130a and wireless signal 132a′ from transmitting device 130b. Similarly, the computing device 120c may be determined to be receiving three wireless signals from communication devices (e.g., transmitting device 130 and/or 135 and/or computing device 120), namely wireless signal 132c from transmitting device 130a, wireless signal 132c′ from transmitting device 130b, and wireless signal 132c″ from transmitting device 130c. As another example, as illustrated in FIG. 1, the computing device 120′ may be determined to be receiving five wireless signals from five other computing devices (e.g., computing devices 120a, 120b, 120c, 120d, and 120e) that collectively form a mesh network, and such five wireless signals may be wireless signals 131a, 131b, 131c, 131d, and 131e. In yet another example, as illustrated in FIG. 2A, the computing device 120b may be determined to be receiving three wireless signals from three communication devices (e.g., transmitting device 130 and/or 135 and/or computing device 120), namely wireless signal 132b from transmitting device 130b, wireless signal 138a from computing device 120a, and wireless signal 138b from computing device 120c.

In addition to or in replacement, an assessment and/or determination by the computing device (e.g., computing device 120), processor (e.g., processor 110), and/or other computing device of a number/quantity of communication devices (e.g., transmitting devices 130 and/or 135 and/or computing device 120) transmitting the received wireless signals may be performed. For example, as illustrated in FIG. 2C, as computing device 120a is receiving wireless signal 132a from transmitting device 130a and wireless signal 132a′ from transmitting device 130b, the number of transmitting devices determined to be transmitting the received wireless signals to computing device 120a may be two. Similarly, as the computing device 120c is receiving wireless signal 132c from transmitting device 130a, wireless signal 132c′ from transmitting device 130b, and wireless signal 132c″ from transmitting device 130c, the number of transmitting devices determined to be transmitting the received wireless signals to computing device 120c may be three. In another example, as illustrated in FIG. 1, as the computing device 120′ is receiving wireless signal 131a from computing device 120a, wireless signal 131b from computing device 120b, wireless signal 131c from computing device 120c, wireless signal 131d from computing device 120d, and wireless signal 131e from computing device 120e, the number of computing devices determined to be transmitting the received wireless signals to computing device 120′ may be five.

In addition to or in replacement, example embodiments may include determining other information pertaining to one or more of the received wireless signals. Such information may include, but are not limited to, a signal level of one or more wireless signals received from a communication device (e.g., transmitting device 130 and/or 135 and/or computing device 120) and/or a comparison of such signal levels. The information may also include transmission time (e.g., time it takes for a signal to travel from a communication device (e.g., transmitting device 130 and/or 135 and/or computing device 120) to another communication device (e.g., transmitting device 130 and/or 135 and/or computing device 120)), interference on the signal, etc. In addition to or in replacement, such information may include an identification of the communication device (e.g., transmitting device 130 and/or 135 and/or computing device 120) transmitting one or more of the received wireless signal. For example, when the communication device is a WAP or the like, a signature (e.g., BSSID) may be transmitted along with its wireless signals. As another example, when the communication device is a computing device or the like, a signature for the computing device may be transmitted along with its wireless signals. In addition to or in replacement, information pertaining to the received wireless signals may include an identification of a nearest communication device (e.g., transmitting device 130 and/or 135 and/or computing device 120). The nearest communication device (e.g., transmitting device 130 and/or 135 and/or computing device 120) may be the communication device (e.g., transmitting device 130 and/or 135 and/or computing device 120) associated with the received wireless signal having the strongest signal level from among the received wireless signals (and/or from among the signal levels determined and/or assessed) and/or the received wireless signal having the least or shortest transmission or travel time (e.g., time it takes for the received wireless signal to travel from the communication device (e.g., transmitting device 130 and/or 135 and/or computing device 120) to the communication device (e.g., transmitting device 130 and/or 135 and/or computing device 120) receiving the received wireless signal). For example, for computing device 120a (as illustrated in FIG. 2C), wireless signal 132a may be determined to have the strongest signal level for (and/or shortest travel or transmission time to) computing device 120a from among the two received wireless signals 132a and 132a′. Similarly, for computing device 120c, wireless signal 132c′ may be determined to have the strongest signal level for (and/or shortest travel time to) computing device 120c from among the three received wireless signals 132c, 132c′, and 132c″.

Information pertaining to the received wireless signals may also include an identification of a second nearest communication device (e.g., transmitting device 130 and/or 135 and/or computing device 120). The second nearest communication device (e.g., transmitting device 130 and/or 135 and/or computing device 120) may be the communication device (e.g., transmitting device 130 and/or 135 and/or computing device 120) that is determined to be associated with the received wireless signal having the second strongest signal level (or second shortest travel or transmission time) from among the received wireless signals (and/or from among the signal levels determined and/or assessed). Furthermore, information pertaining to the received wireless signals may include an identification of subsequently nearest, subsequently shortest travel or transmission time, or other communication devices (e.g., transmitting device 130 and/or 135 and/or computing device 120), such as those in the same mesh network, ring network, etc. Other examples are contemplated without departing from the teachings of the present disclosure. As described above and in the present disclosure, an assessment and/or determination of whether or not the computing device (e.g., computing device 120) is in the receiving signal state (e.g., receiving signal state 510) (or other state) may be performed directly by the computing device (e.g., computing device 120) and/or remotely by the processor (e.g., processor 110) and/or another computing device.

In an example embodiment, the receiving signal state (e.g., receiving signal state 510) may, in turn, be determined to be (i) a matched signal state (e.g., matched signal state 512), or (ii) a not matched signal state (e.g., not matched signal state 514), as further described below and in the present disclosure.

(2)(b)(i) The Matched Signal State (e.g., Matched Signal State 512).

The receiving signal state (e.g., receiving signal state 510) may be in a matched signal state (e.g., matched signal state 512) in example embodiments. The matched signal state (e.g., matched signal state 512) of the computing device (e.g., computing device 120) may be a state in which a determination is made by the computing device (e.g., computing device 120), processor (e.g., processor 110), and/or another computing device that information pertaining to a wireless signal received and/or being received (or already received) by the computing device (e.g., computing device 120) matches one or more pre-determined and/or pre-associated information. In an example embodiment, the pre-determined and/or pre-associated information may include a pre-determined or pre-associated identification of a communication device (e.g., transmitting device 130 and/or 135 and/or computing device 120) and/or pre-determined or pre-associated signal level.

The matched signal state (e.g., matched signal state 512) may be determined when an identification of the communication device (e.g., transmitting device 130 and/or 135 and/or computing device 120) that is transmitting or has transmitted the received wireless signal matches an identification of a communication device (e.g., transmitting device 130 and/or 135 and/or computing device 120) pre-associated with and/or pre-determined for the computing device (e.g., computing device 120).

For example, the pre-associated and/or pre-determined communication device (e.g., transmitting device 130 and/or 135 and/or computing device 120) may be a communication device (such as a Wi-Fi access point, wireless Wi-Fi router, computing device 120, or the like) that is set, configured, and/or known to be the communication device (e.g., transmitting device 130 and/or 135 and/or computing device 120) nearest to, sending a strongest signal level, and/or requiring the shortest amount of time for a signal to travel to a certain or pre-determined location. The pre-associated and/or pre-determined communication device (e.g., transmitting device 130 and/or 135 and/or computing device 120) may also be a communication device (such as a Wi-Fi access point, computing device 120, or the like) that is set, configured, and/or known to be a communication device (e.g., transmitting device 130 and/or 135 and/or computing device 120) at a certain or known distance (or distance range) from, sending a certain or known signal level (or signal level range) to, and/or requiring a certain or known amount of travel or transmission time to a certain or pre-determined location. The certain or pre-determined location for a given computing device (e.g., computing device 120) may be an area, room, and/or location of an external energy source (e.g., external energy source 150) associated with, found to be likely or normally associated with, and/or, at a particular day/time, normally associated with (e.g., always, on specific days, during specific times, upon specific events occurring, etc.) the given computing device (e.g., computing device 120). For example, in a situation where an employer has assigned to an employee a computing device (e.g., computing device 120) and the employee is normally assigned/stationed to a particular desk and/or office, the certain or pre-determined location for such computing device (e.g., computing device 120) may be the location of the desk and/or office of the employee and/or one or more external energy sources (e.g., an AC electrical outlet) within the office of the employee during normal working hours (and excluding holidays). In such an example, the communication device (e.g., transmitting device 130 and/or 135 and/or computing device 120) pre-associated with and/or pre-determined for such computing device (e.g., computing device 120) may be a WAP, wireless Wi-Fi router, Li-Fi router, or the like that is nearest to (and/or at a certain distance or distance range from), sending a particular signal level to, sending wireless signals requiring a least or particular amount of time to travel to, and/or sending a strongest signal (and/or certain signal level or signal level range) to the location of the desk, office, and/or one or more external energy sources (e.g., an AC electrical outlet) within the office of the employee. In addition to or in replacement, the communication device (e.g., transmitting device 130 and/or 135 and/or computing device 120) pre-associated with and/or pre-determined for such computing device (e.g., computing device 120) during normal working hours may also be a computing device (e.g., computing device 120) that is nearest to (and/or at a certain distance or distance range from), sending a particular signal level to, sending wireless signals requiring a least or particular amount of time to travel to, and/or sending a strongest signal (and/or certain signal level or signal level range) to the location of the desk, office, and/or one or more external energy sources (e.g., an AC electrical outlet) within the office of the employee. As another example, in a situation where a hotel has assigned to a hotel guest a computing device (e.g., a mobile phone) and the hotel guest is checked into a hotel room, the certain and/or pre-determined location for such computing device (e.g., a mobile phone) may be the location of the hotel room and/or one or more external energy sources (e.g., an AC electrical outlet) within the hotel room. In such an example, the communication device (e.g., transmitting device 130 and/or 135 and/or computing device 120) pre-associated with and/or pre-determined for such computing device (e.g., computing device 120) may be a WAP, wireless Wi-Fi router, Li-Fi router, or the like that is nearest to (and/or at a certain distance or distance range from), sending a particular signal level to, sending wireless signals requiring a least or particular amount of time to travel to, and/or sending a strongest signal (and/or certain signal level or signal level range) to the location of the hotel room and/or one or more external energy sources (e.g., an AC electrical outlet) within the hotel room of the hotel guest. In addition to or in replacement, the communication device (e.g., transmitting device 130 and/or 135 and/or computing device 120) pre-associated with and/or pre-determined for such computing device (e.g., computing device 120) during the hotel guest's stay may also be one or more other computing devices (e.g., computing device 120) (e.g., computing devices for one or more other hotel guests staying adjacent to the location of the hotel room and/or computing devices that are part of the same network).

As described above, the pre-associated and/or pre-determined computing device (e.g., computing device 120) may be another computing device (e.g., computing device 120) that is set, configured, and/or known to be a computing device (e.g., computing device) nearest to, sending a particular signal level to, sending wireless signals requiring a least or particular amount of time to travel to, and/or sending a strongest signal level to the certain or pre-determined location referred to above and in the present disclosure. The pre-associated and/or pre-determined computing device (e.g., computing device 120) may also be another computing device (e.g., computing device 120) that is normally set, configured, and/or known to be a computing device (e.g., computing device 120) at a certain distance (or distance range) from, sending a certain signal level (or signal level range) to, and/or sending wireless signals requiring a certain amount of time to travel to the certain or pre-determined location referred to above and in the present disclosure. As described above, the certain or pre-determined location for each computing device (e.g., computing device 120) may be an area, room, and/or location of an external energy source (e.g., external energy source 150) associated with or found to be likely or normally associated with each computing device (e.g., computing device 120). For example, in a situation where an employer has assigned to an employee a computing device (e.g., computing device 120), the employee is assigned/stationed to a particular desk and/or office, and the certain or pre-determined location for such computing device (e.g., computing device 120) is the location of the desk, office, and/or one or more external energy sources (e.g., external energy source 150) within the office, the pre-associated and/or pre-determined computing device (e.g., computing device 120) for such computing device (e.g., computing device 120) may be a computing device (e.g., computing device 120) that is normally nearest to (and/or at a certain distance or distance range from), normally sending a strongest signal (and/or certain signal level or signal level range) to, and/or normally sending wireless signals requiring the least amount of time to travel to the location of the desk, office, and/or one or more external energy sources (e.g., external energy source 150) within the office of that employee. Such pre-associated and/or pre-determined computing device (e.g., computing device 120) may be, for example, a computing device (e.g., computing device) assigned to another employee who is assigned/stationed to a desk and/or office that is adjacent or nearby the desk and/or office of the employee. As another example, in a situation where a hotel has assigned to a hotel guest a computing device (e.g., computing device 120) and the hotel guest is checked into a hotel room, the certain and/or pre-determined location for such computing device (e.g., computing device 120) may be the location of the hotel room and/or computing devices in the same network. In such an example, the pre-associated and/or pre-determined computing device (e.g., computing device 120) may be a computing device (e.g., computing device 120) of one or more hotel guests that are in another hotel room adjacent or nearest to (and/or at a certain distance or distance range from) the location of the hotel room and/or one or more external energy sources (e.g., external energy source 150) within the hotel room of the hotel guest. The pre-associated and/or pre-determined computing device (e.g., computing device 120) may also be another computing device (e.g., computing device 120) that has been assigned, set, known, or expected to be one that will be nearby the computing device (e.g., computing device 120) for or during a particular time period, such as in situations where two or more separate hotel guests, two or more tourists in a tour group, etc. (each with a separate computing device (e.g., computing device 120)) are in a group and will be nearby/traveling with each other (in the case of hotel guests, both in the hotel and outside of the hotel) during their hotel stay, tour session, etc.

In an example embodiment, a determination of the matched signal state (e.g., matched signal state 512) for a given computing device (e.g., computing device 120) may require a determination of all of the following: (i) an identification of the communication device (e.g., transmitting device 130 and/or 135 and/or computing device 120) that is transmitting or has transmitted the received wireless signal to the given computing device (e.g., computing device 120) matches an identification of a communication device (e.g., transmitting device 130 and/or 135 and/or computing device 120) pre-associated with and/or pre-determined for the given computing device (e.g., computing device 120), and (ii) one or both of the following: (a) a signal level of a wireless signal received by the given computing device (e.g., computing device 120) matches a signal level or signal level range pre-associated with and/or pre-determined for the given computing device (e.g., computing device 120), and/or (b) a time required for a wireless signal to travel to the given computing device (e.g., computing device 120) matches a time or time range pre-associated with and/or pre-determined for the given computing device (e.g., computing device 120).

As an example, in a situation where computing device 120a (illustrated in FIG. 2B) has a pre-associated and/or pre-determined communication device being the communication device 130a, pre-associated signal level(s) being a certain value (or range), and/or pre-associated signal travel time being a certain value or range, the matched signal state (e.g., matched signal state 512) may be determined for the computing device 120a when the computing device 120a is receiving a wireless signal having a signal level value matching that of the pre-associated signal level (or range), the identification of the communication device transmitting the received wireless signal matches that of the pre-associated communication device 130a, and/or the time required for the wireless signal to travel from the communication device to the computing device 120a matches that of the pre-associated travel time (or range). In such an example, the matched signal state (e.g., matched signal state 512) may be determined when the computing device 120a is located at the location of the external energy source 150a (i.e., the location where computing device 120a is depicted in FIG. 2A to be located).

If, however, the pre-associated and/or pre-determined communication device and pre-associated and/or pre-determined signal level and/or travel/transmission time for the computing device 120a (as illustrated in FIG. 2B) remain the same as the aforementioned example but the computing device 120a is moved to a different location (e.g., the location where computing device 120b is depicted in FIG. 2B to be located; the location where computing device 120c is depicted in FIG. 2B to be located; the location where computing device 120d is depicted in FIG. 2B to be located; or one or more other locations), the receiving signal state (e.g., receiving signal state 510) may not be determined to be the matched signal state (e.g., matched signal state 512) (i.e., will be determined to be the not matched signal state (e.g., not matched signal state 514)) since the pre-associated and/or pre-determined signal level and/or travel/transmission time and the pre-associated and/or pre-determined communication device for computing device 120a may not match. As a more specific example, in a situation where the location of computing device 120a is the location where computing device 120b is depicted in FIG. 2B to be located, although such a location may receive wireless signals from the same communication device 130a (i.e., the pre-associated and/or pre-determined communication device for the computing device 120a may match), the signal level and/or transmission/travel time may not match the pre-associated signal level. Similarly, in a situation where the location of computing device 120a is the location where computing device 120c is depicted in FIG. 2B to be located, although such a location may have a signal level that matches the pre-associated and/or pre-determined signal level and/or transmission/travel time, the identification of the communication device transmitting the received wireless signal may not match the pre-associated and/or pre-determined communication device 130a.

In another example embodiment, a determination of the matched signal state (e.g., matched signal state 512) for a given computing device (e.g., computing device 120) may require a determination that (i) an identification of the computing device (e.g., computing device 120) that is transmitting or has transmitted the received wireless signal to the given computing device (e.g., computing device 120) matches an identification of a computing device (e.g., computing device 120) pre-associated with and/or pre-determined for the given computing device (e.g., computing device 120), and (ii) one or both of the following: (a) a signal level of a wireless signal received by the given computing device (e.g., computing device 120) matches a signal level or signal level range pre-associated with and/or pre-determined for the given computing device (e.g., computing device 120), and/or (b) a time required for a wireless signal to travel to the given computing device (e.g., computing device 120) matches a time or time range pre-associated with and/or pre-determined for the given computing device (e.g., computing device 120).

As an example, in a situation where computing device 120a (illustrated in FIG. 2B) has a pre-associated and/or pre-determined computing device being the computing device 120b, pre-associated signal level(s) being a certain value (or range), and/or pre-associated signal travel time being a certain value or range, the matched signal state (e.g., matched signal state 512) may be determined for the computing device 120a when the computing device 120a is receiving a wireless signal having a signal level value matching that of the pre-associated signal level, the identification of the computing device transmitting the received wireless signal matches that of the pre-associated computing device 120b, and/or the time required for the wireless signal to travel from the computing device 120b to the computing device 120a matches that of the pre-associated travel time (or range). In such an example, the matched signal state (e.g., matched signal state 512) may be determined when the computing device 120a is located at the location of the external energy source 150a (i.e., the location where computing device 120a is depicted in FIG. 2A to be located).

If, however, the pre-associated and/or pre-determined computing device and pre-associated and/or pre-determined signal level and/or travel/transmission time for the computing device 120a (as illustrated in FIG. 2B) remain the same as the aforementioned example but the computing device 120a is moved to a different location (e.g., the location where computing device 120b is depicted in FIG. 2B to be located; the location where computing device 120c is depicted in FIG. 2B to be located; the location where computing device 120d is depicted in FIG. 2B to be located; or one or more other locations), the receiving signal state (e.g., receiving signal state 510) may not be determined to be the matched signal state (e.g., matched signal state 512) (i.e., will be determined to be the not matched signal state (e.g., not matched signal state 514)) since the pre-associated and/or pre-determined signal level and/or travel/transmission time and the pre-associated and/or pre-determined computing device for computing device 120a may not match. As a more specific example, in a situation where the location of computing device 120a is the location where computing device 120b is depicted in FIG. 2B to be located, although such a location may receive wireless signals from the computing device 120b (i.e., the pre-associated and/or pre-determined computing device for the computing device 120a may match), the signal level may not match the pre-associated signal level (i.e., the signal level will be stronger since the devices are closer in distance).

In example embodiments, a determination of the matched signal state (e.g., matched signal state 512) may also require matching of more than one communication device (e.g., transmitting device 130 and/or 135 and/or computing device 120), matching of signal levels from more than one received wireless signal, and/or matching of more than one travel/transmission times, such as the use of a mesh network of communication devices (e.g., transmitting device 130 and/or 135 and/or computing device 120). It is recognized in the present disclosure that requiring matching of more than one communication device (e.g., transmitting device 130 and/or 135 and/or computing device 120), matching of signal levels from more than one received wireless signal, and/or matching of more than one travel/transmission times may be more accurate and/or advantageous in certain situations, such as situations where the certain and/or pre-determined location for each computing device (e.g., computing device 120) is relatively close to one another, there is a relatively high density of certain and/or pre-determined locations, and/or there is a relatively high number of wireless signals and/or received wireless signals. Other example situations are contemplated without departing from the teachings of the present disclosure.

In another example embodiment, a determination of the matched signal state (e.g., matched signal state 512) for a given computing device (e.g., a first computing device) may require: (i) a determination that an identification of one or more transmitting computing devices (e.g., a second computing device) that are transmitting or have transmitted the received wireless signals to the given computing device (e.g., first computing device) match identifications of computing devices pre-associated with and/or pre-determined for the given computing device (e.g., the given computing device and one or more transmitting computing devices are in a pre-determined or pre-associated mesh network), (ii) a determination that an identification of one or more other transmitting computing devices (e.g., a third computing device) that are transmitting or have transmitted received wireless signals to the one or more transmitting computing devices (e.g., second transmitting device) match identifications of computing devices pre-associated with and/or pre-determined for the one or more transmitting computing devices and/or given computing device (e.g., the one or more other transmitting computing devices, the one or more transmitting computing devices, and the given computing device are in the same pre-determined or pre-associated mesh network), (iii) a determination that a signal level of each of the wireless signals received by the given computing device (e.g., first computing device) match signal levels or signal level ranges pre-associated with and/or pre-determined for the given computing device (e.g., matching signal levels and identification of the transmitting computing devices to those of pre-associated and/or pre-determined computing devices for the given computing device); and (iv) a determination that a signal level of each of the wireless signals received by one or more of the transmitting computing devices (e.g., second computing device) match signal levels or signal level ranges pre-associated with and/or pre-determined for the one or more transmitting computing devices and/or given computing device (e.g., matching signal levels and identification of other transmitting computing devices to those of pre-associated and/or pre-determined transmitting computing devices for the transmitting computing devices).

The pre-associating and/or predetermining of identification(s) of the one or more communication devices (e.g., transmitting device 130 and/or 135 and/or computing device 120) and/or the pre-associating and/or predetermining of signal level(s) (or signal level range(s)) for any given computing device (e.g., computing device 120), as described above and in the present disclosure, may be performed during set up and/or maintenance of the system (e.g., system 100) and/or periodically, scheduled, continuously, and/or on demand.

As described above and in the present disclosure, an assessment and/or determination of whether or not the computing device (e.g., computing device 120) is in the matched signal state (e.g., matched signal state 512) (or other state) may be performed directly by the computing device (e.g., computing device 120) and/or remotely by the processor (e.g., processor 110) and/or another computing device.

(2)(b)(ii) The not Matched Signal State (e.g., not Matched Signal State 514).

The receiving signal state (e.g., receiving signal state 510) may be a not matched signal state (e.g., not matched signal state 514) in example embodiments. The not matched signal state (e.g., not matched signal state 514) may be a receiving signal state (e.g., received signal state 510) that is a state other than a matched signal state (e.g., matched signal state 512), and vice versa. For example, the not matched signal state (e.g., not matched signal state 514) may be a state in which a determination is made by the computing device (e.g., computing device 120), processor (e.g., processor 110), and/or another computing device that information pertaining to a wireless signal being received (or already received) by the computing device (e.g., computing device 120) does not match one or more pre-determined and/or pre-associated information.

In an example embodiment, the pre-determined and/or pre-associated information may include an identification of a communication device (e.g., transmitting device 130 and/or 135 and/or computing device 120) and/or a signal level and/or travel/transmission time in a similar manner described above and in the present disclosure. For example, the not matched signal state (e.g., not matched signal state 514) may be determined when an identification of the communication device (e.g., transmitting device 130 and/or 135 and/or computing device 120) that is transmitting or has transmitted the received wireless signal is determined to not match an identification of one or more communication devices (e.g., transmitting device 130 and/or 135 and/or computing device 120) pre-associated with and/or pre-determined for the computing device (e.g., computing device 120). In addition to or in replacement, a determination of the not matched signal state (e.g., not matched signal state 514) may require a determination that a signal level of one or more of the received wireless signal does not match one or more signal levels or signal level ranges pre-associated with and/or pre-determined for the computing device (e.g., computing device 120). In addition to or in replacement, a determination of the not matched signal state (e.g., not matched signal state 514) may require a determination that a travel/transmission time of one or more of the received wireless signal does not match one or more travel/transmission time or travel/transmission time ranges pre-associated with and/or pre-determined for the computing device (e.g., computing device 120).

In example embodiments, a determination of the not matched signal state (e.g., not matched signal state 514) may require not matching of more than one communication device (e.g., transmitting device 130 and/or 135 and/or computing device 120) and/or not matching of signal levels and/or travel/transmission times from more than one received wireless signal.

As described above and in the present disclosure, an assessment and/or determination of whether or not the computing device (e.g., computing device 120) is in the not matched signal state (e.g., not matched signal state 514) (or other state) may be performed directly by the computing device (e.g., computing device 120) and/or remotely by the processor (e.g., processor 110) and/or another computing device.

In an example embodiment, the computing device (e.g., computing device 120) described herein may be directed to and/or include mobile computing devices, smart phones, mobile phones, PDAs phablets, tablets, portable computers, laptops, notebooks, ultrabooks, readers, electrical devices, media players, specialized devices (e.g., a dedicated or specialized device to communicate with and/or operate in the system (e.g., system 100), or parts thereof), a plurality of computing devices interacting together in part or in whole, and other specialized computing devices and industry-specific computing devices. The computing device (e.g., computing device 120) described herein may also be directed to and/or include wearable computing devices, including watches (such as the Apple Watch), glasses, etc. The computing device (e.g., computing device 120) may also may be and/or include a virtual machine, computer, node, instance, host, or machine in a networked computing environment. Such networked environment, and/or cloud, may be a collection of machines connected by communication channels that facilitate communications between machines and allow for machines to share resources. Such resources may encompass any types of resources for running instances including hardware (such as servers, clients, mainframe computers, networks, network storage, data sources, memory, central processing unit time, scientific instruments, and other computing devices), as well as software, software licenses, available network services, and other non-hardware resources, or a combination thereof.

Processor (e.g., Processor 110).

As illustrated in at least FIG. 1, FIGS. 2A-C, and FIG. 3, the system (e.g., system 100) may include one or more processors (e.g., processor 110). The processor (e.g., processor 110) may be any processor, device, computing device, mobile computing device, controller, microprocessor, microcontroller, microchip, semiconductor device, or the like, configurable or configured to perform a processing of information, wireless communications, and/or other predetermined actions. The processor (e.g., processor 110) may also include or be a part of a virtual machine, computer, node, instance, host, or machine in a networked computing environment. As used in the present disclosure, such a network and/or cloud (e.g., network 140, 140′, 140″), may be a collection of devices connected by communication channels that facilitate communications between devices and allow for devices to share resources. Such resources may encompass any types of resources for running instances including hardware (such as servers, clients, mainframe computers, networks, network storage, data sources, memory, central processing unit time, scientific instruments, and other computing devices), as well as software, software licenses, available network services, and other non-hardware resources, or a combination thereof. A network or cloud may include, but is not limited to, computing grid systems, peer to peer systems, mesh-type systems, distributed computing environments, cloud computing environment, etc. Such network or cloud may include hardware and software infrastructures configured to form a virtual organization comprised of multiple resources which may be in geographically disperse locations. Network may also refer to a communication medium between processes on the same device. Also as referred to herein, a network element, node, or server may be a device deployed to execute a program operating as a socket listener and may include software instances.

An example embodiment of the processor (e.g., processor 120) may be in communication with one or more elements of the system (e.g., system 100). For example, the processor (e.g., processor 120) may be in communication with the one or more computing devices (e.g., computing device 120), one or more communication devices (e.g., transmitting devices 130 and/or 135 and/or computing device 120), and/or one or more networks (e.g., network 140).

The processor (e.g., processor 110) may be configurable or configured to perform wireless communications through 3G networks, 4G networks, 4G LTE networks, or the like (e.g., network 140′ and/or 140″). In addition to or in replacement, the processor (e.g., processor 110) may be configurable or configured to perform wireless communications via WLANs, such as Wi-Fi networks and Li-Fi networks, and/or via other forms, such as Bluetooth, NFC, and other forms of short range wireless signals (e.g., network for transmitting devices 130 and/or 135 and/or computing device 120). One or more of the aforementioned wireless communications may be between example embodiments of the processor (e.g., processor 110) and one or more computing devices (e.g., computing device 120), one or more communication devices (e.g., transmitting devices 130, 135 and/or computing device 120), and/or one or more networks (e.g., network 140).

In an example embodiment, the processor (e.g., processor 110) may be configurable, configured, and/or capable of assessing, determining, receiving, and/or accessing (e.g., from the computing device (e.g., computing device 120)) the current state of the computing device (e.g., computing device 120). As described above and in the present disclosure, the current state of the computing device (e.g., computing device 120) may be any state, such as the charge state (e.g., charge state 400) and/or communication state (e.g., communication state 500) of the computing device (e.g., computing device 120). In respect to the charge state (e.g., charge state 400), the charge state (e.g., charge state 400) may be the charging state (e.g., charging state 410) or the non-charging state (e.g., non-charging state 420), as described above and in the present disclosure. In respect to the charging state (e.g., charging state 410), the charging state (e.g., charging state 410) may be the AC charging state (e.g., AC charging state 412) or the non-AC charging state (e.g., non-AC charging state 414), as described above and in the present disclosure. In respect to the communication state (e.g., communication state 500), the communication state (e.g., communication state 500) may be the receiving signal state (e.g., receiving signal state 510) or the not receiving signal state (e.g., not receiving signal state 520), as described above and in the present disclosure. In respect to the receiving signal state (e.g., receiving signal state 510), the receiving signal state (e.g., receiving signal state 510) may be the matched signal state (e.g., matched signal state 512) or the not matched signal state (e.g., not matched signal state 514), as described above and in the present disclosure.

When the computing device (e.g., computing device 120) is configurable or configured to directly assess and/or determine the current state of the computing device (e.g., computing device 120), such assessed and/or determined current state of the computing device (e.g., computing device 120) may then be transmitted to, accessible to, and/or made available to the processor (e.g., processor 110), either directly or indirectly.

In addition to or in replacement, the processor (e.g., processor 110) may be configurable or configured to receive and/or obtain information from the computing device (e.g., computing device 120), in whole or in part, either directly or indirectly, so as to enable the processor (e.g., processor 110) to perform an assessment and/or determination of the current state of the computing device (e.g., computing device 120). Such information may be received and/or obtained upon the processor (e.g., processor 110) sending instructions to and/or establishing a communication channel with the computing device (e.g., computing device 120), on a periodic basis, based on a predetermined schedule, continuously, and/or based on an event occurring (e.g., when an employee is scheduled or required to be at his/her office or a meeting, when a student is scheduled or required to be in a lecture or taking an examination, and/or when a hotel guest has checked in or out of the hotel).

In an example embodiment, the processor (e.g., processor 110) may be configurable or configured to determine a location and/or location status of a computing device (e.g., computing device 120) based on the current state of the computing device (e.g., computing device 120), including the charge state (e.g., charge state 400) and/or the communication state (e.g., communication state 500) of the computing device (e.g., computing device 120). For example, the processor (e.g., processor 110) may be configurable or configured to establish a communication channel between the computing device (e.g., computing device 120) and the processor (e.g., processor 110). The processor (e.g., processor 110) may be further configurable or configured to receive, such as via the communication channel, a current state (e.g., charge state) of the computing device (e.g., computing device 120) and/or information so as to enable the processor (e.g., processor 110) to assess and/or determine the current state of the computing device (e.g., computing device 120). The current state (e.g., charge state) of the computing device (e.g., computing device 120) may be determined by the processor (e.g., processor 110) to be in a charging state (e.g., charging state 410) or non-charging state (e.g., non-charging state 420). As described above and in the present disclosure, the charging state (e.g., charging state 410) may be a state in which the energy source of the computing device (e.g., computing device 120) is connected to and/or being charged by an external energy source. Furthermore, the non-charging state (e.g., non-charging state 420) may be a state in which the energy source of the computing device is not connected to and/or not being charged by the external energy source. The processor (e.g., processor 110) may also be configurable or configured to receive, such as via the communication channel, a communication state (e.g., communication state 500) of the computing device (e.g., computing device 120). In addition to or in replacement, the processor (e.g., processor 110) may b configurable or configured to receive information pertaining to one or more wireless signals of a wireless local area network (WLAN) or other short range wireless signal received by the computing device (e.g., computing device 120) so as to enable the processor (e.g., processor 110) to assess and/or determine the communication state (e.g., communication state 500) of the computing device (e.g., computing device 120). The information received by the processor (e.g., processor 110) may include an identification of one or more communication devices (e.g., transmitting device 130 and/or 135 and/or computing device 120). In an example embodiment, the information received by the processor (e.g., processor 110) may include information pertaining to a nearest transmitting device (e.g., transmitting device 130 and/or 135 and/or computing device 120). The nearest transmitting device may be the transmitting device associated with the received wireless signal having a strongest signal level or signal level range (and/or shortest travel or transmission time) from among the received wireless signals. The information received by the processor (e.g., processor 110) may also pertain to another communication device (e.g., transmitting device 130 and/or 135 and/or computing device 120). Such other communication device (e.g., transmitting device 130 and/or 135 and/or computing device 120) may be the communication device associated with the received wireless signal having a certain signal level and/or travel/transmission time and/or identification. The information received by the processor (e.g., processor 110) may also pertain to other communication devices (e.g., transmitting device 130 and/or 135 and/or computing device 120), such as those in the same network. The one or more communication devices (e.g., transmitting device 130 and/or 135 and/or computing device 120) may be or include a WAP, computing device, or the like, and the identification of one or more of the communication devices (e.g., transmitting device 130 and/or 150) may include a basis service set identification (BSSID), identification of the computing device, or the like.

The processor (e.g., processor 110) may be configurable or configured to derive a location and/or location status of the computing device (e.g., computing device 120) based on the current state of the computing device (e.g., computing device 120) and the identification of one or more communication devices (e.g., transmitting devices 130 and/or 135 and/or computing device 120). In an example embodiment, the processor (e.g., processor 110) may be configurable or configured to derive a location and/or location status of the computing device (e.g., computing device 120) based on the current state of the computing device (e.g., computing device 120) and the identification of the nearest communication devices (e.g., transmitting devices 130 and/or 135 and/or computing device 120) (e.g., via signal level and/or travel/transmission time). The deriving of the location and/or location status of the computing device (e.g., computing device 120) may also be based on the second nearest communication devices (e.g., transmitting devices 130 and/or 135 and/or computing device 120) and/or other communication devices (e.g., transmitting devices 130 and/or 135 and/or computing device 120) (e.g., via signal level and/or travel/transmission time), as described in the present disclosure. In addition to or in replacement, the deriving of the location and/or location status of the computing device (e.g., computing device 120) may be based on one or more of the signal levels or signal level ranges and/or travel/transmission times or travel/transmission time ranges of the received wireless signals.

In an example embodiment, the location and/or location status determinable by the processor (e.g., processor 110) may be an accurate location status or an approximate location status. The accurate location status may be a status in which a location of the computing device (e.g., computing device 120) can be positively or accurately identified. The approximate location status, on the other hand, may be a status in which the location of the computing device (e.g., computing device 120) can be estimated or approximated, but may not be positively identified.

The processor (e.g., processor 110) may be configurable or configured to derive the location and/or location status to be the accurate location status when (i) the current state of the computing device (e.g., computing device 120) is determined to be the AC charging state (e.g., AC charging state 412), and/or (ii) the identification of the nearest communication devices (e.g., transmitting devices 130 and/or 135 and/or computing device 120) is determined to match the identification of the pre-determined and/or pre-associated communication devices (e.g., transmitting devices 130 and/or 135 and/or computing device 120) that has been assigned and/or associated to the computing device (e.g., computing device 120). In such an example, the deriving of the location and/or location status may be further based on other communication devices (e.g., transmitting devices 130 and/or 135 and/or computing device 120) transmitting wireless signals to the computing device (e.g., computing device 120), such as information pertaining to identification, signal level, travel/transmission time, charge status, and/or communication status, as described above and in the present disclosure.

In another example embodiment, processor (e.g., processor 110) may be configurable or configured to derive the location and/or location status for a given computing device (e.g., a first computing device) to be the accurate location status when (i) an identification of a transmitting device (e.g., a second computing device) transmitting wireless signals to the given computing device (e.g., first computing device) is determined to match the identification of the pre-determined and/or pre-associated transmitting devices that has been assigned and/or associated to the given computing device (e.g., first computing device), and (ii) an identification of one or more other transmitting devices (e.g., third computing device) transmitting wireless signals to the transmitting device (e.g., second computing device) is determined to match the identification of one or more pre-determined and/or pre-associated transmitting devices that have been assigned and/or associated to the transmitting computing device (e.g., second computing device). In such an example embodiment, the deriving of the location and/or location status for the given computing device (e.g., first computing device) may be further based on (i) matching a signal level or signal level range (and/or travel/transmission time) of the wireless signal received by the given computing device (e.g., first computing device) from the one or more transmitting devices (e.g., second computing device) with signal levels or signal level ranges pre-determined for and/or pre-associated with the given computing device (e.g., first computing device), as described above and in the present disclosure, and (ii) matching a signal level or signal level range (and/or travel/transmission time) of the wireless signal received by the transmitting device (e.g., second computing device) from the one or more other transmitting device (e.g., third computing device) with signal levels or signal level ranges pre-determined for and/or pre-associated with the transmitting device (e.g., second computing device), as described above and in the present disclosure. In addition to or in replacement, the deriving of the location and/or location status for the given computing device (e.g., first computing device) may be further based on (i) a current status (e.g., charge status) of the given computing device (e.g., first computing device), as described above and in the present disclosure, (ii) a current status (e.g., charge status) of the one or more transmitting device (e.g., second computing device), as described above and in the present disclosure, and/or (iii) a current status (e.g., charge status) of the one or more other transmitting device (e.g., third computing device), as described above and in the present disclosure. It is recognized in the present disclosure that the aforementioned example embodiments for deriving the location and/or location status of a given computing device (e.g., first computing device) based on, among other things, identification, signal level, travel/transmission time, and/or current status (e.g., charge status and/or communication status) of one or more transmitting devices (e.g., second computing device) and one or more other transmitting devices (e.g., third computing device) may be may be applicable in situations where the given computing device (e.g., first computing device), the one or more transmitting devices (e.g., second computing device), and the one or more other transmitting devices (e.g., third computing device) are configurable or configured in a mesh or ring network configuration such that each such device in the network may be configurable or configured to obtain such information of one, some, or all other devices in the network and/or make such information available to the processor (e.g., processor 110), other devices in the network, and/or other devices outside of the network to perform location determination.

In an example embodiment, the location and/or location status is the accurate location status when the current state is the AC charging state (e.g., AC charging state 412) and the receiving signal state (e.g., receiving signal state 510) is the matched signal state (e.g., matched signal state 512).

In respect to the approximate location status, the processor (e.g., processor 110) may be configurable or configured to derive the location and/or location status to be the approximate location status when the location and/or location status is not the accurate location status, and vice versa.

In an example embodiment, the location and/or location status is the approximate location status when the current state is the AC charging state (e.g., AC charging state 412) and the receiving signal state (e.g., receiving signal state 510) is the not matched signal state (e.g., not matched signal state 514).

For example, the processor (e.g., processor 110) may be configurable or configured to derive the location and/or location status to be the approximate location status when the current state of the computing device (e.g., computing device 120) is the AC charging state (e.g., AC charging state 412) and the identification of the nearest communication devices (e.g., transmitting devices 130 and/or 135 and/or computing device 120) is known to the processor (e.g., processor 110) but does not match the identification of the pre-determined and/or pre-associated communication devices (e.g., transmitting devices 130 and/or 135 and/or computing device 120) that has been assigned to the computing device (e.g., computing device 120). In this case, the estimated location may be determined to be a location outside of the range of the WLAN or other short range wireless signal of the pre-determined and/or pre-associated communication devices (e.g., transmitting devices 130 and/or 135 and/or computing device 120) assigned to the computing device (e.g., computing device 120).

In another example embodiment, the location and/or location status is the approximate location status when the current state is the non-AC charging state (e.g., non-AC charging state 414) and the receiving signal state (e.g., receiving signal state 510) is the matched signal state (e.g., matched signal state 512).

For example, the processor (e.g., processor 110) may also be configurable or configured to derive the location and/or location status to be the approximate location status when the current state of the computing device (e.g., computing device 120) is the non-AC charging state (e.g., non-AC charging state 414) and the identification of the nearest communication devices (e.g., transmitting devices 130 and/or 135 and/or computing device 120) matches the identification of the predetermined communication device that has been assigned to the computing device (e.g., computing device 120). In this case, the estimated location may be an area within a range of the WLAN or other short range wireless signal of the pre-determined and/or pre-associated communication devices (e.g., transmitting devices 130 and/or 135 and/or computing device 120) assigned to the computing device (e.g., computing device 120).

In another example embodiment, the location and/or location status is the approximate location status when the current state is the non-charging state (e.g., non-charging state 420) and the receiving signal state (e.g., receiving signal state 510) is the matched signal state (e.g., matched signal state 512).

For example, the processor (e.g., processor 110) may also be configurable or configured to derive the location and/or location status to be the approximate location status when the current state of the computing device (e.g., computing device 120) is the non-charging state (e.g., non-charging state 420) and the identification of the nearest communication devices (e.g., transmitting devices 130 and/or 135 and/or computing device 120) matches the identification of the predetermined communication devices (e.g., transmitting devices 130 and/or 135 and/or computing device 120) that has been assigned to the computing device (e.g., computing device 120). In this case, the estimated location may be an area within the range of the WLAN or other short range wireless signal of the pre-determined and/or pre-associated communication devices (e.g., transmitting devices 130 and/or 135 and/or computing device 120) assigned to the computing device (e.g., computing device 120).

In another example embodiment, the location and/or location status is the approximate location status when the receiving signal state (e.g., receiving signal state 510) is the not matched signal state (e.g., not matched signal state 520).

For example, the processor (e.g., processor 110) may also be configurable or configured to derive the location and/or location status to be the approximate location status when the identification of the nearest communication devices (e.g., transmitting devices 130 and/or 135 and/or computing device 120) does not match the identification of the predetermined communication devices (e.g., transmitting devices 130 and/or 135 and/or computing device 120) that has been assigned to the computing device (e.g., computing device 120). In this case, the estimated location may be a location outside of the range of the WLAN or other short range wireless signal of the predetermined communication devices (e.g., transmitting devices 130 and/or 135 and/or computing device 120) assigned to the computing device (e.g., computing device 120).

Other examples are contemplated without departing from the teachings of the present disclosure.

First Example Embodiment of a Method of Determining a Location and/or Location Status of a Computing Device (e.g., Method 600).

In an example embodiment, a method (e.g., method 600) of determining a location and/or location status of a computing device may utilize some or all of the elements of system (e.g., system 100) described above and in the present disclosure.

Example embodiments of the method (e.g., method 600) may include, but are not limited to, one or more of the following actions: (1) assessing a current state (e.g., charge state) of the computing device (e.g., action 602); (2) determining whether the computing device is receiving wireless signals (e.g., action 604); (3) assessing a current state (e.g., communication state) of the computing device (e.g., action 606); and (4) deriving the location and/or location status of the computing device (e.g., 608).

Example embodiments of the system (e.g., system 100) may be used according to one or more of the above and below actions, may include additional actions, may be performable in different sequences, and/or one or more of the actions may be combinable into a single action or divided into two or more actions. These actions will now be explained with references to the figures.

(1) Assessing a Current State (e.g., Charge State) of the Computing Device (e.g., Action 602).

The method (e.g., method 600) may include assessing a current state of the computing device (e.g., computing device 120) (e.g., action 602). As described above and in the present disclosure, the current state (e.g., charge state 400) of the computing device (e.g., computing device 120) may be a charging state (e.g., charging state 410) or a non-charging state (e.g., non-charging state 420). The charging state (e.g., charging state 410) may be a state in which the energy source of the computing device (e.g., computing device 120) is connected to and/or being charged by an external energy source. The non-charging state (e.g., non-charging state 420) may be a state in which the energy source of the computing device is not connected to and/or not being charged by the external energy source.

(2) Determining Whether the Computing Device is Receiving Wireless Signals (e.g., Action 604).

The method (e.g., method 600) may include determining whether the computing device is receiving wireless signals (e.g., action 604). As described above and in the present disclosure, the received wireless signals may be any wireless signal, including those associated with a WAN or another form of short range wireless signal. In an example embodiment, the method (e.g., method 600) may perform such determination for only received wireless signals associated with a WAN, another form of short range wireless signal, or a signal from a pre-associated and/or pre-determined computing device.

(3) Assessing a Current State (e.g., Communication State) of the Computing Device (e.g., Action 606).

In an example embodiment, the method (e.g., method 600) may include assessing a current state (e.g., communication state 500) of the computing device (e.g., computing device 120) (e.g., action 606). As described above and in the present disclosure, the assessing of the communication state (e.g., communication state 500) may include determining information pertaining to one or more of the wireless signals received by the computing device (e.g., computing device 120). The information may include an identification of one or more communication devices (e.g., transmitting device 130 and/or 135 and/or computing device 120). In an example embodiment, the information may include a signal level or signal level range and/or travel/transmission time or travel/transmission time range for each of the one or more received wireless signals. The information may also include a nearest communication device (e.g., transmitting devices 130 and/or 135 and/or computing device 120). The nearest communication device (e.g., transmitting devices 130 and/or 135 and/or computing device 120) may be the communication device associated with the received wireless signal having a strongest signal level and/or shortest travel/transmission time from among the received wireless signals. The information may also include a second nearest communication device (e.g., transmitting devices 130 and/or 135 and/or computing device 120). The second nearest communication device (e.g., transmitting devices 130 and/or 135 and/or computing device 120) may be the communication device associated with the received wireless signal having a second strongest signal level or signal level range and/or second shortest travel/transmission time or range from among the received wireless signals. The information may also include other communication devices (e.g., transmitting devices 130 and/or 135 and/or computing device 120). The one or more communication devices (e.g., transmitting devices 130 and/or 135 and/or computing device 120) may be or include a WAP, computing device, or the like, and the identification of one or more of the communication devices (e.g., transmitting devices 130 and/or 135 and/or computing device 120) may include a basis service set identification (BSSID), identification of a computing device, or the like.

(4) Deriving a Location and/or Location Status of the Computing Device (e.g., Action 608).

The method (e.g., method 600) may include deriving a location and/or location status of the computing device (e.g., action 608). As described above and in the present disclosure, the deriving of the location and/or location status may be performed based on the current state (e.g., charge state 400) of the computing device (e.g., computing device 120) and/or the identification of one or more identified communication devices (e.g., transmitting devices 130 and/or 135 and/or computing device 120). In an example embodiment, a location and/or location status of the computing device (e.g., computing device 120) may be derived based on the current state of the computing device (e.g., computing device 120) and/or the identification of the nearest communication devices (e.g., transmitting devices 130 and/or 135 and/or computing device 120). The deriving of the location and/or location status of the computing device (e.g., computing device 120) may also be based on the second nearest communication device (e.g., transmitting devices 130 and/or 135 and/or computing device 120) and/or other nearest communication devices (e.g., transmitting devices 130 and/or 135 and/or computing device 120). In addition to or in replacement, the deriving of the location and/or location status of the computing device (e.g., computing device 120) may be based on one or more of the signal levels and/or travel/transmission times of the received wireless signals.

In an example embodiment, the location and/or location status may be an accurate location status or an approximate location status, as described above and in the present disclosure. The accurate location status may be a status in which a location of the computing device (e.g., computing device 120) can be positively or accurately identified. The approximate location status, on the other hand, may be a status in which the location of the computing device (e.g., computing device 120) can be estimated or approximated, but may not be positively or accurately identified.

The location and/or location status may be the accurate location status when the current state of the computing device (e.g., computing device 120) is the AC charging state (e.g., AC charging state 412) and/or the identification of the nearest communication device (e.g., transmitting devices 130 and/or 135 and/or computing device 120) matches the identification of the pre-determined and/or pre-associated communication device (e.g., transmitting devices 130 and/or 135 and/or computing device 120) that has been assigned and/or associated to the computing device (e.g., computing device 120). In an example embodiment, the location and/or location status is the accurate location status when the current state (e.g., charge state 400) is the AC charging state (e.g., AC charging state 412) and/or the receiving signal state (e.g., receiving signal state 510) is the matched signal state (e.g., matched signal state 512). In a specific embodiment, the location and/or location status is the accurate location status when all of the following apply: the current state (e.g., charge state 400) is the AC charging state (e.g., AC charging state 412) and the receiving signal state (e.g., receiving signal state 510) is the matched signal state (e.g., matched signal state 512).

The location and/or location status may also be the approximate location status when the current state (e.g., charge state 400) of the computing device (e.g., computing device 120) is the AC charging state (e.g., Ac charging state 412) and/or the identification of the nearest communication device (e.g., transmitting devices 130 and/or 135 and/or computing device 120) does not match the identification of the pre-determined and/or pre-associated communication device (e.g., transmitting devices 130 and/or 135 and/or computing device 120) that has been assigned to the computing device (e.g., computing device 120). In a specific embodiment, the location and/or location status may also be the approximate location status when all of the following apply: the current state (e.g., charge state 400) of the computing device (e.g., computing device 120) is the AC charging state (e.g., Ac charging state 412) and the identification of the nearest communication device (e.g., transmitting devices 130 and/or 135 and/or computing device 120) does not match the identification of the pre-determined and/or pre-associated communication device (e.g., transmitting devices 130 and/or 135 and/or computing device 120) that has been assigned to the computing device (e.g., computing device 120). In this case, the estimated location may be determined to be a location outside of the range of the WLAN or other short range wireless signal of the pre-determined and/or pre-associated communication device (e.g., transmitting devices 130 and/or 135 and/or computing device 120) assigned to the computing device (e.g., computing device 120).

The location and/or location status may also be the approximate location status when the current state (e.g., charge state 400) of the computing device (e.g., computing device 120) is the non-AC charging state (e.g., non-AC charging state 414) and/or the identification of the nearest communication device (e.g., transmitting devices 130 and/or 135 and/or computing device 120) matches the identification of the predetermined communication device that has been assigned to the computing device (e.g., computing device 120). In a specific embodiment, the location and/or location status may also be the approximate location status when all of the following apply: the current state (e.g., charge state 400) of the computing device (e.g., computing device 120) is the non-AC charging state (e.g., non-AC charging state 414) and the identification of the nearest communication device (e.g., transmitting devices 130 and/or 135 and/or computing device 120) matches the identification of the predetermined communication device that has been assigned to the computing device (e.g., computing device 120). In this case, the estimated location may be an area within a range of the WLAN or other short range wireless signal of the pre-determined and/or pre-associated communication devices (e.g., transmitting devices 130 and/or 135 and/or computing device 120) assigned to the computing device (e.g., computing device 120).

The location and/or location status may also be the approximate location status when the current state (e.g., charge state 400) of the computing device (e.g., computing device 120) is the non-charging state (e.g., non-charging state 420) and/or the identification of the nearest communication device (e.g., transmitting devices 130 and/or 135 and/or computing device 120) matches the identification of the predetermined communication device (e.g., transmitting devices 130 and/or 135 and/or computing device 120) that has been assigned to the computing device (e.g., computing device 120). In a specific embodiment, the location and/or location status may also be the approximate location status when all of the following apply: the current state (e.g., charge state 400) of the computing device (e.g., computing device 120) is the non-charging state (e.g., non-charging state 420) and the identification of the nearest communication device (e.g., transmitting devices 130 and/or 135 and/or computing device 120) matches the identification of the predetermined communication device (e.g., transmitting devices 130 and/or 135 and/or computing device 120) that has been assigned to the computing device (e.g., computing device 120). In this case, the estimated location may be an area within the range of the WLAN or other short range wireless signal of the pre-determined and/or pre-associated communication device (e.g., transmitting devices 130 and/or 135 and/or computing device 120) assigned to the computing device (e.g., computing device 120).

The location and/or location status may also be the approximate location status when the identification of the nearest communication device (e.g., transmitting devices 130 and/or 135 and/or computing device 120) is known (e.g., known to the processor and/or computing device) but does not match the identification of the predetermined communication device (e.g., transmitting devices 130 and/or 135 and/or computing device 120) that has been assigned to the computing device (e.g., computing device 120). In this case, the estimated location may be a location outside of the range of the WLAN or other short range wireless signal of the predetermined communication device (e.g., transmitting devices 130 and/or 135 and/or computing device 120) assigned to the computing device (e.g., computing device 120).

Other examples are contemplated without departing from the teachings of the present disclosure.

Second Example Embodiment of a Method of Determining a Location and/or Location Status of a Computing Device (e.g., Method 700).

In an example embodiment, a method (e.g., method 700) of determining a location and/or location status of a computing device may utilize some or all of the elements of the system (e.g., system 100) described above and in the present disclosure.

Example embodiments of the method (e.g., method 700) may include, but are not limited to, one or more of the following actions: (1) establishing a communication channel (e.g., action 702); (2) assessing a current state (e.g., charge state) of the computing device (e.g., action 704); (3) assessing a current state (e.g., communication state) of the computing device (e.g., action 706); and (4) deriving the location and/or location status of the computing device (e.g., action 708).

Example embodiments of the system (e.g., system 100) may be used according to one or more of the above and below actions, may include additional actions, may be performable in different sequences, and/or one or more of the actions may be combinable into a single action or divided into two or more actions. These actions will now be explained with references to the figures.

(1) Establishing a Communication Channel (e.g., Action 702).

The method (e.g., method 700) may include establishing a communication channel (e.g., action 702). The communication channel may be established between the processor (e.g., processor 110) and the computing device (e.g., computing device 120). Other communication channels may also be established, such as communication channels between the processor and one or more other computing devices, communication devices, and/or networks. In example embodiments, the communication channel may utilize or traverse through one or more networks (e.g., network 140) or the cloud. The communication channel may be a wireless communication channel, wired communication channel, or combination of these.

(2) Assessing a Current State (e.g., Charge State) of the Computing Device (e.g., Action 704).

The method (e.g., method 700) may include assessing a current state of the computing device (e.g., computing device 120) (e.g., action 704). As described above and in the present disclosure, the processor (e.g., processor 110) may be configurable to receive, via the communication channel, a current state (e.g., charge state 400) of the computing device (e.g., computing device 120). In addition to or in replacement, the processor (e.g., processor 110) may be configurable to receive, via the communication channel, information so as to enable the processor (e.g., processor 110) to assess and/or determine the current state (e.g., charge state 400) of the computing device (e.g., computing device 120). The current state (e.g., charge state 400) of the computing device (e.g., computing device 120) may be determined by the computing device (e.g., computing device 120) and/or the processor (e.g., processor 110) to be in a charging state (e.g., charging state 410) or non-charging state (e.g., non-charging state 420). The charging state (e.g., charging state 410) may be a state in which the energy source of the computing device (e.g., computing device 120) is connected to and/or being charged by an external energy source. The non-charging state (e.g., non-charging state 420) may be a state in which the energy source of the computing device is not connected to and/or not being charged by the external energy source.

(3) Assessing a Current State (e.g., Communication State) of the Computing Device (e.g., Action 706).

The method (e.g., method 700) may include assessing a communication state (e.g., communication state 500) of the computing device (e.g., computing device 120) (e.g., action 706). As described above and in the present disclosure, the assessing of the communication state (e.g., communication state 500) may include receiving, by the processor (e.g., processor 110) via the communication channel, the communication state (e.g., communication state 500) of the computing device (e.g., computing device 120). In addition to or in replacement, the processor (e.g., processor 110) may receive information pertaining to one or more wireless signals of a WLAN or other short range wireless signal received by the computing device so as to enable the processor (e.g., processor 110) to assess and/or determine the communication state (e.g., communication state 500) of the computing device (e.g., computing device 120). The information received by the processor (e.g., processor 110) may include an identification of one or more communication devices (e.g., transmitting device 130 and/or 135 and/or computing device 120). In an example embodiment, the information received by the processor (e.g., processor 110) may include a nearest communication device (e.g., transmitting devices 130 and/or 135 and/or computing device 120). The nearest communication device may be the communication device associated with the received wireless signal having a strongest signal level or signal level range and/or shortest travel/transmission time or travel/transmission time range from among the received wireless signals. The information received by the processor (e.g., processor 110) may also include a second nearest communication device (e.g., transmitting devices 130 and/or 135 and/or computing device 120). The second nearest communication device may be the communication device associated with the received wireless signal having a second strongest signal level or signal level range and/or second shortest travel/transmission time or travel/transmission time range from among the received wireless signals. The information received by the processor (e.g., processor 110) may also include other nearest communication devices (e.g., transmitting devices 130 and/or 135 and/or computing device 120). The one or more communication devices (e.g., transmitting devices 130 and/or 135 and/or computing device 120) may be or include a WAP, computing device, or the like, and the identification of one or more of the communication devices (e.g., transmitting devices 130 and/or 135 and/or computing device 120) may include a basis service set identification (BSSID), identification of a computing device, or the like.

(4) Deriving a Location and/or Location Status of the Computing Device (e.g., Action 708).

The method (e.g., method 700) may include deriving a location and/or location status of the computing device (e.g., computing device 120)(e.g., action 708). As described above and in the present disclosure, the deriving of the location and/or location status may be performed by the processor (e.g., processor 110) based on the current state (e.g., charge state 400) of the computing device (e.g., computing device 120) and/or the identification of one or more identified communication devices (e.g., transmitting devices 130 and/or 135 and/or computing device 120). In an example embodiment, the processor (e.g., processor 110) may then be configurable or configured to derive a location and/or location status of the computing device (e.g., computing device 120) based on the current state (e.g., charge state 400) of the computing device (e.g., computing device 120) and/or the identification of the nearest communication devices (e.g., transmitting devices 130 and/or 135 and/or computing device 120). The deriving of the location and/or location status of the computing device (e.g., computing device 120) may also be based on the second nearest communication device (e.g., transmitting devices 130 and/or 135 and/or computing device 120) and/or other nearest communication devices (e.g., transmitting devices 130 and/or 135 and/or computing device 120). In addition to or in replacement, the deriving of the location and/or location status of the computing device (e.g., computing device 120) may be based on one or more of the signal levels or signal level ranges and/or travel/transmission times or travel/transmission time ranges of the received wireless signals.

In an example embodiment, the location and/or location status determinable by the processor (e.g., processor 110) may be an accurate location status or an approximate location status. The accurate location status is a status in which a location of the computing device (e.g., computing device 120) can be positively or accurately identified. The approximate location status, on the other hand, is a status in which the location of the computing device (e.g., computing device 120) can be estimated or approximated, but may not be positively or accurately identified.

The processor (e.g., processor 110) may be configurable or configured to derive the location and/or location status to be the accurate location status when the current state (e.g., charge sate 400) of the computing device (e.g., computing device 120) is the AC charging state (e.g., AC charging state 412) and/or the identification of the nearest communication device (e.g., transmitting devices 130 and/or 135 and/or computing device 120) matches the identification of the pre-determined and/or pre-associated communication device (e.g., transmitting devices 130 and/or 135 and/or computing device 120) that has been assigned and/or associated to the computing device (e.g., computing device 120). In a specific embodiment, the location and/or location status is the accurate location status when all of the following apply: the current state (e.g., charge state 400) is the AC charging state (e.g., AC charging state 412) and the receiving signal state (e.g., receiving signal state 510) is the matched signal state (e.g., matched signal state 512).

The processor (e.g., processor 110) may be configurable or configured to derive the location and/or location status to be the approximate location status when the current state (e.g., charge state 400) of the computing device (e.g., computing device 120) is the AC charging state (e.g., AC charging state 412) and/or the identification of the nearest communication device (e.g., transmitting devices 130 and/or 135 and/or computing device 120) does not match the identification of the pre-determined and/or pre-associated transmitting device (e.g., transmitting device 130 and/or 135) that has been assigned to the computing device (e.g., computing device 120). In a specific embodiment, the location and/or location status may be the approximate location status when all of the following apply: the current state (e.g., charge state 400) of the computing device (e.g., computing device 120) is the AC charging state (e.g., AC charging state 412) and the identification of the nearest communication device (e.g., transmitting devices 130 and/or 135 and/or computing device 120) does not match the identification of the pre-determined and/or pre-associated transmitting device (e.g., transmitting device 130 and/or 135) that has been assigned to the computing device (e.g., computing device 120). In this case, the estimated location may be determined to be a location outside of the range of the WLAN or other short range wireless signal of the pre-determined and/or pre-associated communication device (e.g., transmitting devices 130 and/or 135 and/or computing device 120) assigned to the computing device (e.g., computing device 120).

The processor (e.g., processor 110) may also be configurable or configured to derive the location and/or location status to be the approximate location status when the current state (e.g., charge state 400) of the computing device (e.g., computing device 120) is the non-AC charging state (e.g., non-AC charging state 420) and/or the identification of the nearest communication device (e.g., transmitting devices 130 and/or 135 and/or computing device 120) matches the identification of the predetermined transmitting device that has been assigned to the computing device (e.g., computing device 120). In a specific embodiment, the location and/or location status may be the approximate location status when all of the following apply: the current state (e.g., charge state 400) of the computing device (e.g., computing device 120) is the non-AC charging state (e.g., non-AC charging state 420) and the identification of the nearest communication device (e.g., transmitting devices 130 and/or 135 and/or computing device 120) matches the identification of the predetermined transmitting device that has been assigned to the computing device (e.g., computing device 120). In this case, the estimated location may be an area within a range of the WLAN or other short range wireless signal of the pre-determined and/or pre-associated communication device (e.g., transmitting devices 130 and/or 135 and/or computing device 120) assigned to the computing device (e.g., computing device 120).

The processor (e.g., processor 110) may also be configurable or configured to derive the location and/or location status to be the approximate location status when the current state (e.g., charge state 400) of the computing device (e.g., computing device 120) is the non-charging state (e.g., non-charging state 420) and the identification of the nearest communication device (e.g., transmitting devices 130 and/or 135 and/or computing device 120) matches the identification of the predetermined communication device (e.g., transmitting devices 130 and/or 135 and/or computing device 120) that has been assigned to the computing device (e.g., computing device 120). In a specific embodiment, the location and/or location status may be the approximate location status when all of the following apply: the current state (e.g., charge state 400) of the computing device (e.g., computing device 120) is the non-charging state (e.g., non-charging state 420) and the identification of the nearest communication device (e.g., transmitting devices 130 and/or 135 and/or computing device 120) matches the identification of the predetermined communication device (e.g., transmitting devices 130 and/or 135 and/or computing device 120) that has been assigned to the computing device (e.g., computing device 120). In this case, the estimated location may be an area within the range of the WLAN or other short range wireless signal of the pre-determined and/or pre-associated communication device (e.g., transmitting devices 130 and/or 135 and/or computing device 120) assigned to the computing device (e.g., computing device 120).

The processor (e.g., processor 110) may also be configurable or configured to derive the location and/or location status to be the approximate location status when the identification of the nearest communication device (e.g., transmitting devices 130 and/or 135 and/or computing device 120) is known but does not match the identification of the predetermined communication device (e.g., transmitting devices 130 and/or 135 and/or computing device 120) that has been assigned to the computing device (e.g., computing device 120). In this case, the estimated location may be a location outside of the range of the WLAN or other short range wireless signal of the predetermined communication device (e.g., transmitting devices 130 and/or 135 and/or computing device 120) assigned to the computing device (e.g., computing device 120).

Other examples are contemplated without departing from the teachings of the present disclosure.

While various embodiments in accordance with the disclosed principles have been described above, it should be understood that they have been presented by way of example only, and are not limiting. Thus, the breadth and scope of the example embodiments described in the present disclosure should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

For example, “electrically connected,” “electrical connection,” “electrical communication,” “electrically communicated,” or other similar terms should generally be construed broadly to mean a wired, wireless, and/or other form of, as applicable, connection between two or more elements which enable an electric current to pass through, a voltage to be applied, and/or power to be supplied and/or transferred (each as applicable).

Also, as referred to herein, a processor, computing device, electrical device, and/or controller, may be any processor, computing device, and/or communication device, and may include a virtual machine, computer, node, instance, host, or machine in a networked computing environment. Also as referred to herein, a network or cloud may be or include a collection of machines connected by communication channels that facilitate communications between machines and allow for machines to share resources. Network may also refer to a communication medium between processes on the same machine. Also as referred to herein, a network element, node, or server may be a machine deployed to execute a program operating as a socket listener and may include software instances.

Database (or memory or storage) may comprise any collection and/or arrangement of volatile and/or non-volatile components suitable for storing data. For example, memory may comprise random access memory (RAM) devices, read-only memory (ROM) devices, magnetic storage devices, optical storage devices, solid state devices, and/or any other suitable data storage devices. In particular embodiments, database may represent, in part, computer-readable storage media on which computer instructions and/or logic are encoded. Database may represent any number of memory components within, local to, and/or accessible by a processor and/or computing device.

Various terms used herein have special meanings within the present technical field. Whether a particular term should be construed as such a “term of art” depends on the context in which that term is used. For example, “connect,” “connected,” “connecting,” “connectable,” “attach,” “attached,” “attaching,” “attachable,” “secure,” “secured,” “securing,” “securable,” “install,” “installed,” “installing,” “installable,” “couple,” “coupled,” “coupling,” “in communication with,” “communicating with,” “associated with,” “associating with,” or other similar terms should generally be construed broadly to include situations where attachments, connections, installations, and anchoring are direct between referenced elements or through one or more intermediaries between the referenced elements. As another example, “un-connect,” “un-connected,” “un-connecting,” “un-connectable,” “un-attach,” “un-attached,” “un-attaching,” “un-attachable,” “un-secure,” “un-secured,” “un-securing,” “un-securable,” “uninstall,” “uninstalled,” “uninstalling,” “uninstallable,” “uncouple,” “uncoupled,” “uncoupling,” or other similar terms should generally be construed broadly to include situations where separation, removal, and detaching are direct between referenced elements or from one or more intermediaries between the referenced elements. These and other terms are to be construed in light of the context in which they are used in the present disclosure and as one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings and topic headings herein are provided for consistency with the suggestions under various patent regulations and practice, or otherwise to provide organizational cues. These headings shall not limit or characterize the embodiments set out in any claims that may issue from this disclosure. Specifically, a description of a technology in the “Background” is not to be construed as an admission that technology is prior art to any embodiments in this disclosure. Furthermore, any reference in this disclosure to “invention” in the singular should not be used to argue that there is only a single point of novelty in this disclosure. Multiple inventions may be set forth according to the limitations of the claims issuing from this disclosure, and such claims accordingly define the invention(s), and their equivalents, that are protected thereby. In all instances, the scope of such claims shall be considered on their own merits in light of this disclosure, but should not be constrained by the headings herein.

1. A system for determining a location of a computing device, the system comprising:
a processor, the processor configurable to:
communicate, via a communication channel, with a first computing device;
determine, from the first computing device via the communication channel, a current state of the first computing device, the current state of the first computing device being one of the following states:
a charging state, the charging state being a state in which an energy source of the first computing device is connected to and/or being charged by an external energy source; or
a non-charging state, the non-charging state being a state in which the energy source of the first computing device is not connected to and/or not being charged by the external energy source;
identify, from the first computing device via the communication channel, a second computing device, the second computing device being a computing device transmitting wireless signals directly to the first computing device;
determine, from the first computing device via the communication channel, a current state of the second computing device, the current state of the second computing device being one of the following states:
a charging state, the charging state being a state in which an energy source of the second computing device is connected to and/or being charged by an external energy source; or
a non-charging state, the non-charging state being a state in which the energy source of the second computing device is not connected to and/or not being charged by the external energy source;
determine, from the first computing device via the communication channel, a signal level of the wireless signals received by the first computing device from the second computing device;
identify, from the first computing device via the communication channel, a third computing device, the third computing device being a computing device transmitting wireless signals directly to the second computing device;
determine, from the first computing device via the communication channel, a current state of the third computing device, the current state of the third computing device being one of the following states:
a charging state, the charging state being a state in which an energy source of the third computing device is connected to and/or being charged by an external energy source; or
a non-charging state, the non-charging state being a state in which the energy source of the third computing device is not connected to and/or not being charged by the external energy source;
determine, from the first computing device via the communication channel, a signal level of the wireless signals received by the second computing device from the third computing device;
derive a location status of the first computing device based on at least the identification of the second and third computing devices, the current state of the first computing device, the current state of the second computing device, the current state of the third computing device, and the signal levels of the wireless signals received by the first and second computing devices from the second and third computing devices, respectively.

2. The system of claim 1,
wherein the location status is one of the following statuses:
an accurate location status, the accurate location status being a status in which a location of the first computing device can be positively identified; or
an approximate location status, the approximate location status being a status in which the location of the first computing device can be estimated;
wherein the processor derives the location status to be the accurate location status when:
the identification of the second computing device matches a predetermined computing device identification that has been assigned to the first computing device;
the identification of the third computing device matches a predetermined computing device identification that has been assigned to the second computing device;
the signal level of the wireless signal received by the first computing device from the second computing device is a signal level that has been assigned to the first computing device; and
the signal level of the wireless signal received by the second computing device from the third computing device is a signal level that has been assigned to the second computing device.

3. The system of claim 2, wherein the deriving of the location status to be the accurate location status further requires the current state of the first computing device to be in the charging state, the current state of the second computing device to be in the charging state, and the current state of the third computing device to be in the charging state.

4. A method for determining a location of a computing device, the method comprising:
establishing a communication channel between a processor and a first computing device;
determining, by the processor via the communication channel, a current state of the first computing device, the current state of the first computing device being one of the following states:
a charging state, the charging state being a state in which an energy source of the first computing device is connected to and/or being charged by an external energy source; or
a non-charging state, the non-charging state being a state in which the energy source of the first computing device is not connected to and/or not being charged by the external energy source;
identifying, by the processor via the communication channel, a second computing device, the second computing device being a computing device transmitting wireless signals directly to the first computing device;
determining, by the processor via the communication channel, a current state of the second computing device, the current state of the second computing device being one of the following states:
a charging state, the charging state being a state in which an energy source of the second computing device is connected to and/or being charged by an external energy source; or
a non-charging state, the non-charging state being a state in which the energy source of the second computing device is not connected to and/or not being charged by the external energy source;
determining, by the processor via the communication channel, a signal level of the wireless signals received by the first computing device from the second computing device;
identifying, by the processor via the communication channel, a third computing device, the third computing device being a computing device transmitting wireless signals directly to the second computing device;
determining, by the processor via the communication channel, a current state of the third computing device, the current state of the third computing device being one of the following states:
a charging state, the charging state being a state in which an energy source of the third computing device is connected to and/or being charged by an external energy source; or
a non-charging state, the non-charging state being a state in which the energy source of the third computing device is not connected to and/or not being charged by the external energy source;
determining, by the processor via the communication channel, a signal level of the wireless signals received by the second computing device from the third computing device;
deriving a location status of the first computing device based on at least the identification of the second and third computing devices, the current state of the first computing device, the current state of the second computing device, the current state of the third computing device, and the signal levels of the wireless signals received by the first and second computing devices from the second and third computing devices, respectively.

5. The method of claim 4,
wherein the location status is one of the following statuses:
an accurate location status, the accurate location status being a status in which a location of the first computing device can be positively identified; or
an approximate location status, the approximate location status being a status in which the location of the first computing device can be estimated;
wherein the processor derives the location status to be the accurate location status when:
the identification of the second computing device matches a predetermined computing device identification that has been assigned to the first computing device;
the identification of the third computing device matches a predetermined computing device identification that has been assigned to the second computing device;
the signal level of the wireless signal received by the first computing device from the second computing device is a signal level that has been assigned to the first computing device; and
the signal level of the wireless signal received by the second computing device from the third computing device is a signal level that has been assigned to the second computing device.

6. The method of claim 5, wherein the deriving of the location status to be the accurate location status further requires the current state of the first computing device to be in the charging state, the current state of the second computing device to be in the charging state, and the current state of the third computing device to be in the charging state.

7-19. (canceled)

20. A method of determining a location of a computing device, the method comprising:
establishing a communication channel between a processor and a first computing device;
determining, by the first computing device, an identification of a second computing device, the second computing device being a computing device transmitting wireless signals directly to the first computing device;
determining, by the first computing device, a signal level of the wireless signals received by the first computing device from the second computing device;
determining, by the first computing device, an identification of a third computing device, the third computing device being a computing device transmitting wireless signals directly to the second computing device;
determining, by the first computing device, a signal level of the wireless signals received by the second computing device from the third computing device;
deriving, by the first computing device, a location status of the first computing device based on at least the identification of the second and third computing devices and the signal levels of the wireless signals received by the first and second computing devices from the second and third computing devices, respectively; and
receiving, by the processor via the communication channel, the location status of the first computing device.

21. (canceled)

22. The method of claim 20,
further comprising determining, by the first computing device, a current state of the first computing device, the current state of the first computing device being one of the following states:
a charging state, the charging state being a state in which an energy source of the first computing device is connected to and/or being charged by an external energy source; or
a non-charging state, the non-charging state being a state in which the energy source of the first computing device is not connected to and/or not being charged by the external energy source;
wherein the deriving of the location status of the first computing device is further based on the current state of the first computing device.

23. The method of claim 20,
further comprising receiving, by the first computing device, a current state of the second computing device, the current state of the second computing device being one of the following states:
a charging state, the charging state being a state in which an energy source of the second computing device is connected to and/or being charged by an external energy source; or
a non-charging state, the non-charging state being a state in which the energy source of the second computing device is not connected to and/or not being charged by the external energy source;
wherein the deriving of the location status of the first computing device is further based on the current state of the second computing device.

24. The method of claim 20,
further comprising receiving, by the first computing device, a current state of the third computing device, the current state of the third computing device being one of the following states:
a charging state, the charging state being a state in which an energy source of the third computing device is connected to and/or being charged by an external energy source; or
a non-charging state, the non-charging state being a state in which the energy source of the third computing device is not connected to and/or not being charged by the external energy source;
wherein the deriving of the location status of the first computing device is further based on the current state of the third computing device.

25. The method of claim 20,
further comprising:
determining, by the first computing device, an identification of one or more other second computing devices, the one or more other second computing devices being computing devices transmitting wireless signals directly to the first computing device;
determining, by the processor via the communication channel, a signal level of the wireless signals received by the first computing device from the one or more other second computing devices;
determining, by the processor via the communication channel, an identification of one or more other third computing device, the one or more other third computing devices being computing devices transmitting wireless signals directly to the second computing device; and
determining, by the processor via the communication channel, a signal level of the wireless signals received by the second computing device from the one or more other third computing device;
wherein the deriving of the location status of the first computing device is further based on the identification of the one or more other second computing devices, the one or more other third computing devices, the signal levels of the wireless signals received by the first computing device from the one or more other second computing devices, and the signal levels of the wireless signals received by the second computing device from the one or more other third computing devices.

26. The method of claim 20,
wherein the location status is one of the following statuses:
an accurate location status, the accurate location status being a status in which a location of the first computing device can be positively identified; or
an approximate location status, the approximate location status being a status in which the location of the first computing device can be estimated;
wherein the processor derives the location status to be the accurate location status when:
the identification of the second computing device matches a predetermined computing device identification that has been assigned to the first computing device;
the identification of the third computing device matches a predetermined computing device identification that has been assigned to the second computing device;
the signal level of the wireless signal received by the first computing device from the second computing device is a signal level that has been assigned to the first computing device; and
the signal level of the wireless signal received by the second computing device from the third computing device is a signal level that has been assigned to the second computing device.

27. The method of claim 20,
wherein the charging state is one of the following states:
an alternating current (AC) charging state, the AC charging state being a state in which the energy source of the first computing device is connected to and/or being charged by an AC external energy source; or
a non-alternating current (non-AC) charging state, the non-AC charging state being a state in which the energy source of the first computing device is connected to and/or being charged by a non-AC external energy source;
wherein when the processor assesses the current state to be the charging state, the processor is further configurable to determine whether the charging state is the AC charging state or the non-AC charging state;
wherein the location status is one of the following statuses:
an accurate location status, the accurate location status being a status in which a location of the first computing device can be positively identified; or
an approximate location status, the approximate location status being a status in which the location of the first computing device can be estimated;
wherein the processor derives the location status to be the accurate location status when:
the current state of the first computing device is the AC charging state;
the identification of the second computing device matches a predetermined computing device identification that has been assigned to the first computing device;
the identification of the third computing device matches a predetermined computing device identification that has been assigned to the second computing device;
the signal level of the wireless signal received by the first computing device from the second computing device is a signal level that has been assigned to the first computing device; and
the signal level of the wireless signal received by the second computing device from the third computing device is a signal level that has been assigned to the second computing device.
